(19) United States
(12) Patent Application Publication
(10) Pub. No.: US 2024/0419951 A1
(43) Pub. Date: Dec. 19, 2024

(54) ALL-OPTICAL ULTRAFAST NONLINEAR ACTIVATION FUNCTIONS FOR DEEP LEARNING

(71) Applicant: California Institute of Technology, Pasadena, CA (US)

(72) Inventors: Gordon H.Y. Li, Pasadena, CA (US); Ryoto Sekine, Pasadena, CA (US); Rajveer Nehra, Pasadena, CA (US); Robert M. Gray, Pasadena, CA (US); Alireza Marandi, Pasadena, CA (US)

(73) Assignee: California Institute of Technology, Pasadena, CA (US)

(21) Appl. No.: 17/973,118

(22) Filed: Oct. 25, 2022

Related U.S. Application Data
(60) Provisional application No. 63/271,488, filed on Oct. 25, 2021.

(51) Int. Cl. G06N 3/048; G06N 3/067

(52) U.S. Cl. CPC G06N 3/048; G06N 3/0675

(57) ABSTRACT

A device implementing a nonlinear activation function including a material having nonlinear susceptibility phase-matching a coherent nonlinear interaction involving a signal comprising a signal wavelength and a bias comprising a bias wavelength, so that (1) a first phase difference between the signal and the bias induces the interaction comprising second harmonic generation (generating a second harmonic of the bias wavelength) or sum frequency generation (generating a sum frequency of the bias and the signal, and (2) a second phase difference between the signal and the bias induces the interaction comprising parametric amplification amplifying the bias and attenuating the signal. A positive input to the nonlinear activation function is represented by the signal having an input energy and the first phase difference. A negative input is represented by second phase difference. The output is an output energy of the signal as function of the input energy.

### CROSS REFERENCE TO RELATED APPLICATIONS

This application claims the benefit under 35 U.S.C. Section 119(e) of co-pending and commonly-assigned U.S. provisional patent application Ser. No. 63/271,488 filed on Oct. 25, 2021, by Gordon H. Y Li, Ryoto Sekine, Rajveer Nehra, Alireza Marandi, and Robert M. Gray, entitled “ALL-OPTICAL ULTRAFAST NONLINEAR ACTIVATION FUNCTIONS FOR DEEP LEARNING” client reference CIT-8729-P, which application is incorporated by reference herein.

### STATEMENT REGARDING FEDERALLY SPONSORED RESEARCH AND DEVELOPMENT

This invention was made with government support under Grant No. FA9550-20-1-0040 awarded by the Air Force, under Grant No. W911NF-18-1-0285 awarded by the Army and under Grant No(s). CCF1918549 & ECCS1846273 awarded by the National Science Foundation. The government has certain rights in the invention

### BACKGROUND OF THE INVENTION

### 1. Field of the Invention

This invention relates to nonlinear activation functions and methods of making the same.

### 2. Description of the Related Art

Over the past decade, deep learning has revolutionized many important applications including computer vision, speech recognition, and natural language processing [1]. However, the explosive growth of modern deep learning models has quickly outpaced improvements in conventional von Neumann computing architectures and ushered in the use of dedicated hardware accelerators. The quest for ever-faster and more energy-efficient hardware for deep learning began with exploiting the graphics processing unit (GPU), then application-specific integrated circuits such as Google's tensor processing unit (TPU), and more recently the development of non-von Neumann analog architectures [2,3]. Naturally, photonics has attracted attention as a promising candidate due to its potential for massive parallelism and ultrafast operation [4]. Indeed, optical neural networks (ONNs) have been experimentally demonstrated in a variety of platforms including free-space optics [5-11], optical fiber [12-17], and photonic integrated circuits [18-22].

In general, deep neural networks require two major types of computations: (1) linear operations in the form of matrix multiplications and convolutions, which represent the synaptic connections of the network, and (2) nonlinear activation functions, which represent the neuron activations. ONNs excel at performing energy-efficient linear operations in the optical domain, which forms the bulk of computations for deep learning. However, a major remaining roadblock is achieving scalable energy-efficient nonlinear activation functions, which comprises a smaller but essential part of the deep learning workload. Thus, the majority of ONN implementations still opt to utilize digital electronics to perform the nonlinear activation functions. In doing so, the optoelectronic and analog to—digital conversion typically imposes significant speed and energy limitations. On the other hand, the demonstrated all-optical approaches based on various processes [7,13,17,19,23-25] are still too energy-intensive and/or slow compared to electronics. This is because photon-photon interactions are typically weak and require either high light intensities or high-Q resonant cavities, both of which are undesirable for scalable computing purposes. An all-optical, ultrafast, and energy-efficient nonlinear activation function is yet to be demonstrated to unlock the full capabilities of ONNs. Such a function should also be compact, highly scalable, and compatible with existing deep learning models. The present invention satisfies this need.

### SUMMARY OF THE INVENTION

This present disclosure describes the implementation of nonlinear activation functions using nonlinear susceptibility of nonlinear materials. Example methods, devices and systems include, but are not limited to, the following:
1. A device for implementing a nonlinear activation function, comprising:
   a material comprising a (e.g., spatially varying dielectric) second order nonlinear susceptibility phase-matching a coherent (e.g., second-order) nonlinear interaction involving a signal comprising a signal wavelength and a bias comprising a bias wavelength, so that:
   a first phase difference between the signal and the bias induces the interaction comprising second harmonic generation (generating a second harmonic of the bias wavelength) or sum frequency generation (generating a sum frequency of the bias and the signal, and
   a second phase difference between the signal and the bias induces the interaction comprising parametric amplification amplifying the bias and attenuating the signal; and
   wherein:
   an input for receiving:
      a positive input comprising the signal having an input energy and the first phase difference, or
      a negative input comprising the second phase difference, and
   an output for outputting, in response to the input, an output signal comprising an output energy of the signal outputted from the material as a function of the input energy of the signal inputted to the nonlinear material.
2. The device of example 1, wherein the material comprises lithium niobate, lithium tantalate, Potassium Titanyl Phosphate (KTP), aluminum nitride, gallium arsenide, indium phosphide, or aluminum gallium arsenide.
3. The device of example 1, wherein the material comprises a periodically poled ferromagnetic material or an orientation of the nonlinear susceptibility patterned along a length of the material.
4. The device of example 1, further comprising:
   at least one bulk component comprising the material and selected from a fiber coupled nonlinear waveguide or bulk crystal, or
   one or more photonic waveguides each comprising the material, the waveguides each having a thickness on the order of the signal wavelength so as to confine and guide the signal along the waveguide.
5. The device of example 1, wherein the signal comprises a second harmonic of the bias, the first phase difference is π/2, and the second phase difference is −π/2.
6. A photonic integrated circuit comprising the device of example 1, further comprising:
   a chip substrate;
   one or more photonic waveguides, each comprising the material, on the chip substrate;
   one or more bias input couplers, each of the bias input couplers coupling the bias into a different one of the photonic waveguides; and
   the input comprising one or more signal input couplers, each of the signal input couplers coupling the signal into a different one of the photonic waveguides.
7. The photonic circuit of example 6, further comprising a first circuit performing linear operations and a second circuit comprising the photonic waveguides performing the nonlinear activation functions, wherein outputs of the first circuits comprise the signals inputted into the photonic waveguides of the second circuit.
8. The photonic circuit of example 7, wherein the first circuit comprises Mach Zehnder interferometers each having a pair of arms and a plurality of electrooptic modulators, each electro-optic modulator coupled to a least one of the arms so as to modulate a phase of the signal in at least one of the arms.
9. The photonic circuit of example 6, further comprising:
   one or more feedback loops between the output of each of the photonic waveguides and the input of the each of the photonic waveguides, wherein each of the feedback loops performs a linear operation and each feedback loop comprises a modulator for addressing each of the feedback loops at a different time step in a time-multiplexed configuration.
10. A system comprising the device of example 1, further comprising:
   a first source outputting the signal;
   a second source outputting the bias;
   a first amplitude modulator modulating the input energy of the signal;
   a second amplitude modulator modulating an energy of the bias; and
   a delay line or a phase modulator in a path transmitting the signal from the laser to the input to the nonlinear material, wherein the delay line or phase modulator sets the first phase difference or the second phase difference.
11. The system of example 10, further comprising a computer:
   outputting control signals to at least one of the first source, the second source, the first amplitude modulator, the second amplitude modulator, or the delay line or the phase modulator, wherein the control signals control the input energy and set the first phase difference and the second phase difference; and
   receiving the output signal.
12. The system of example 10, further comprising one or more detectors coupled output of the material for measuring the output energy of the signal and outputting a detection signal in response thereto, and wherein the detector detects the output signal comprising an analog (continuous) output.
13. The system of example 10, wherein:
   the first source comprises a first laser outputting first electromagnetic radiation comprising the signal; and
   the second source comprises:
   a second laser outputting second electromagnetic radiation comprising the bias, wherein the first laser and the second laser are coherently coupled so that the first electromagnetic radiation is coherent with the second electromagnetic radiation, or
   the second source comprises a frequency modulator modulating a wavelength of the signal so as to form the bias.
14. The system of example 13, wherein the frequency modulator comprises a half harmonic generator or an optical parametric oscillator.
15. The system of example 10, further comprising a feedback between the detector and the delay line or the phase modulator for locking the first phase difference or the second phase difference.
16. The device of example 1, wherein:
   the response of the nonlinear activation function is determined by an energy of the bias,
   the nonlinear activation function comprises a RELU function, an ELU function, a GELU function, the nonlinear activation function resulting from different energies of the bias, or the nonlinear function resulting from pump (signal) depleted second harmonic generation in the absence of the bias, and
   the phase matching is such that the nonlinear activation function is implemented with pulses of the signal wave each having the input energy less than:
   100 femtojoules and pulses of the bias wave each having an energy less than 100 femtojoules and a duration of less than 100 femtoseconds, or
   1000 picojoules and the pulses of the bias wave each having an energy of less than 1000 picojoules and the duration of less than 1000 picoseconds.
17. An optical neural network comprising the device of example 1, wherein the optical neural network implements machine learning.
18. A method of implementing a nonlinear activation function, comprising:
   inputting a positive input or a negative input, using a signal and a bias, to each of one or more waveguides each comprising a material comprising (e.g., a spatially varying dielectric) second order nonlinear susceptibility phase-matching a coherent (e.g, second-order) nonlinear interaction involving the signal comprising a signal wavelength and the bias comprising a bias wavelength, wherein:
   a first phase difference between the signal and the bias induces the interaction comprising second harmonic generation (generating a second harmonic of the bias) or sum frequency generation (generating a sum frequency of the bias and the signal), and
   a second phase difference between the signal and the bias induces the interaction comprising parametric amplification amplifying the bias and attenuating the signal;
   wherein the positive input to the nonlinear activation function comprises the signal having an input energy and the first phase difference and the negative input to the nonlinear activation function comprising the second phase difference, and
   outputting an output signal from the nonlinear activation function in response to the positive input or the negative input, the output signal comprising an output energy of the signal outputted from each of the waveguides as a function of the input energy of the signal inputted to each of the waveguides.
19. The method of example 18, further comprising inputting the signal from one or more input layers performing linear operations, wherein the input layers are coupled to the nonlinear activation functions using spatial multiplexing or time division multiplexing.
20. The method of example 18, further comprising:
   implementing the nonlinear activation function in a neural network comprising one or more first layers and one or more second layers,
   inputting the signal and the bias from the one or more first layers; and
   outputting the output signals to the one or more second layers.

### BRIEF DESCRIPTION OF THE DRAWINGS

Referring now to the drawings in which like reference numbers represent corresponding parts throughout:

FIGS. 1A-1B: Operating principle of the all-optical ReLU function using a nonlinear photonic waveguide. FIG. 1A For positive inputs with phase of ϕ_{2ω}=+π/2, the phase relationship between the signal and bias is 2ϕ_{ω}−ϕ_{2ω}=π/2, which causes SHG that depletes ω and amplifies 2ω. FIG. 1B: For negative inputs, ϕ_{2ω}=−λ/2, the phase relationship 2ϕ_{ω}−ϕ_{2ω}=3π/2→−π/2 causes DOPA that amplifies ω and depletes 2ω.

FIGS. 2A-2C: Images of the PPLN nanophotonic waveguide. FIG. 2A. Scanning electron microscope image of the ridge waveguide. FIG. 2B Two-photon absorption microscope image of the PPLN ferroelectric domains with poling period of 5 m. FIG. 2C Simulated electric field distributions of the fundamental TE modes at 1045 nm (2ω) and 2090 nm (ω).

FIG. 3: Output signal pulse energy versus input signal pulse energy for both negative and positive inputs. There is good agreement between the ideal ReLU function (dashed black line), simulation (dashed blue line) and experimental results (red circles) for a bias pulse energy of E_{ω}(0)=270f], and signal pulse energies of femtojoules per activation.

FIGS. 4A-4B: Other variants of the ReLU function can be approximated by tuning the bias pulse energy. For example, the FIG. 4A ELU function using bias pulse energy of E_{ω}(0)=450f] and FIG. 4B GELU function using bias pulse energy of E_{ω}(0)=910f]. Ideal function curves are shown by the dashed black lines, and experimental results with red circles.

FIG. 5: Pump-probe ultrafast timing measurements of the ReLU dynamics. The autocorrelation (yellow circles shifted vertically for clarity) of the input ω pulse is well-explained by a Gaussian profile (purple line) with FWHM of (56.4±1.5) fs. The pump-probe signal obtained at a fixed pulse energy (blue circles) is fit (orange line) by convolving the input autocorrelation with exponential growth and decay for positive and negative time delays, respectively. The best fit yields a rise time of (18.9±1.9) fs and a fall time of (28.4±1.1)fs.

FIGS. 6A-6B: Simulated deep learning performance of the experimentally measured all-optical ReLU function for MNIST handwritten digits image classification.

FIG. 6A: A pretrained CNN was used where the ideal ReLU layers are replaced with custom layers representing the experimentally measured ReLU response (after shifting/scaling) then fine-tuned by training for 2 epochs (batch size of 128) to improve the test accuracy (blue line) back to the ideal pretrained model accuracy (dashed black line). FIG. 6B: Confusion matrix on the MNIST task for the final network, which achieved 99.13% test accuracy.

FIG. 7: Comparison of energy and time per activation of the first-third examples of the present invention (red star) to other all-optical (red circle), optoelectronic (blue square), analog electronic (green diamond), and digital electronic (magenta triangle) nonlinear activation functions. The numeric labels show reference numbers and dashed black lines show the energy-time product contours. to the imperfect phase-matching and fabrication error of our device. It is worth mentioning how these device-level metrics potentially translate to those of complete neural networks. In this case, additional system-level energy costs such as laser wall-plug efficiency and transport losses can significantly increase the effective activation energy. However, it is noted that the same is also true in digital electronics such as GPUs where electrical data movement energy costs can exceed the actual switching energy by several orders of magnitude [48].

FIG. 8. Experimental Schematic for all-optical ReLU measurements. The pump laser at 1045 nm is first split into two paths. One beam is used to pump the SPDOPO above threshold generating signal at centered at 2090 nm. The other beam is guided to a delay stage and further overlaps with the 2090 nm OPO signal at a dichroic mirror. Both beams are then coupled in and out from the chip using high NA reflective objectives. Next, the waveguide output is filtered with a short pass filter for filtering out the 2090 nm followed by splitting 1045 nm into two paths. Both of the 1045 nm beams are coupled into multimode fibers; one beam is measured by the OSA while the other beam is used to lock the delay stage. PBS: Polarizing beamsplitter, HWP: Half-wave plate, DM: Dichroic mirror, Obj. Reflective objective, VND: Variable neutral-density filter, LPF: Long-pass filter, SPF: Short-pass filter, FC: Fiber Coupler, OSA: Optical spectrum analyzer, PD: Photodetector, OPO: Optical parametric oscillator.

FIGS. 9A-9B. Measured spectrums of ω and 2ω. FIG. 9A and FIG. 9B correspond to the waveguide input 2ω and a, respectively. FIG. 9C shows the evolution of the waveguide output 2ω as the phase difference between 2ω and ω is modulated.

FIG. 10. Number of signal photons as the input pump power is varied. The red points are experimentally measured data for several values of pump power and the black curve shows the exponential fit used for estimating the output coupling efficiency, i.e., the η₁ parameter in Eq. S2.

FIG. 11. Simulated ReLU-like nonlinear activation function with sub-femtojoule energies achieved using bias pulse energy of Eω(0)=10f] and ideal PPLN parameters.

FIG. 12. Pretrained convolutional neural network architecture.

FIGS. 13A-13B. Potential Integrated photonic neural networks using the all-optical ultrafast ReLU function. FIG. 13A Spatially-multiplexed design based on a mesh of Mach-Zehnder interferometers performing linear operations, directly cascaded into an array of PPLNs performing the ReLU activations. FIG. 13B. Time-multiplexed design based on feedback-modulated delay loops performing linear operations and the PPLN performing ReLU activations, acting as the single photonic neuron folded in time.

FIG. 14 illustrates a hardware environment for controlling the devices described herein.

FIG. 15 is a flowchart illustrating a method of making a device or system implementing a nonlinear activation function.

FIG. 16 is a flowchart illustrating a method of implementing a nonlinear activation function.

### DETAILED DESCRIPTION OF THE INVENTION

In the following description of the preferred embodiment, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

### Technical Description

### First Example: Device and Operation

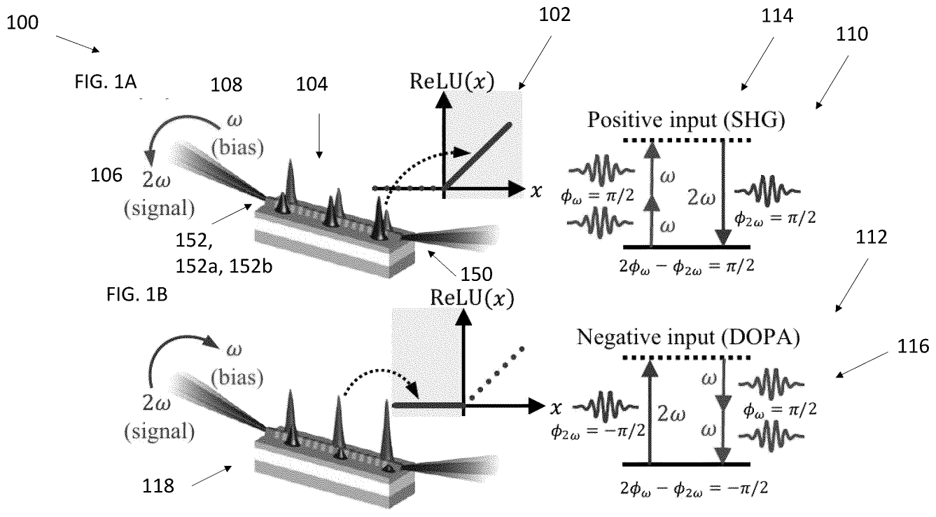

FIG. 1 illustrates an example device and operation method. We encode the signal information into the coherent optical field of pulses centered at frequency 2ω, with positive values represented by ϕ_{2ω}=+π2 phase states, and negative values represented by ϕ_{2ω}=−π2 phase states. By co-propagating the signal pulses with bias pulses centered at frequency a, with fixed input power and phase at ϕ_{ω}=+π/2, we can induce different nonlinear optical effects for the two possible ϕ_{2ω} signal phases depending on the value of the phase relationship 2ϕ_{ω}−ϕ_{2ω}. For the positive signal values with phase ϕ_{2ω}=+π/2, the phase relationship yields 2ϕ_{ω}−ϕ_{2ω}=+π/2. This induces second harmonic generation (SHG), which is a χ⁽²⁾ nonlinear optical process that converts two photons of frequency ω into a photon of frequency 2ω, hence depleting ω and amplifying 2ω. Conversely, for the negative signal values with phase ϕ_{2ω}=−π2, the phase relationship yields 2ϕ_{ω}−ϕ_{2ω}=3π/2→−π/2. This induces degenerate optical parametric amplification (DOPA), which is the inverse process of SHG that converts a photon of frequency 2ω into two photons of frequency ω, hence depleting 2ω and amplifying ω. By judiciously choosing the length and bias power, we can achieve the desired shape of the ReLU function. The system utilizes coherent parametric processes which allows implementing both positive and negative values (i.e. the information is encoded in the field amplitude), unlike other optical [7, 13, 17, 19, 23-25] and optoelectronic methods [11, 14-16, 21, 26-29] based on incoherent absorption processes that can only implement positive values (i.e. the information is encoded in the optical power).

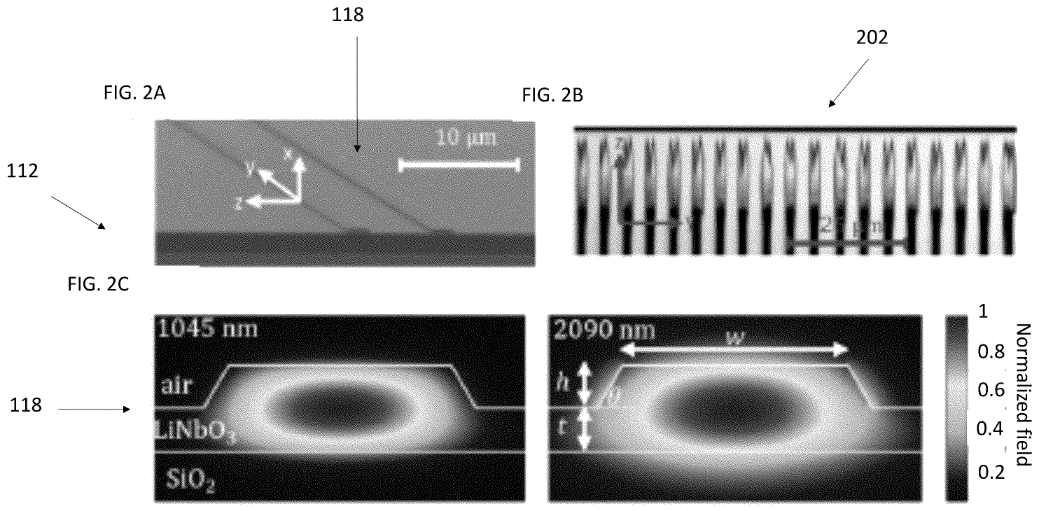

To implement the χ⁽²⁾-based ReLU function, the first example uses a periodically poled thin-film lithium niobate (PPLN) nanophotonic waveguide that exploits the strong and instantaneous χ⁽²⁾ optical nonlinearity of lithium niobate and tight spatial confinement of the waveguide modes to enhance the nonlinearity [30]. Additionally, careful qausi-phase matching and dispersion engineering enables ultra-broadband and low-energy interactions over mm-long propagation lengths, further enhancing the nonlinear optical processes using femtosecond laser pulses [31-33]. Images of the device are shown in FIG. 2. The PPLN nanophotonic waveguide is L=2.5 mm long and was fabricated on a 700-nm thick X-cut MgO—doped lithium niobate thin-film on 2-μm thick SiO₂ with lithium niobate substrate by dry etching with Ar⁺ plasma, achieving smooth ridge side-walls with slant angle of θ≈60° as shown in FIG. 2A. The waveguide was electrically poled with a period of 5.17 μm, as shown in FIG. 2B, to ensure efficient SHG and DOPA. Dispersion engineering of the fundamental TE mode of the ridge waveguide, shown in FIG. 2C, allows for negligible group velocity mismatch and group velocity dispersion of ω and 2ω pulses centered at 1045 and 2090 nm, respectively. This enforces good temporal overlap of the pulses over the entire PPLN propagation length. The ideal parameters found from simulation were a ridge top width of w=1700 nm and etch-depth of h=350 nm. See [33] for further details about fabrication and dispersion engineering of PPLN nanophotonic waveguides.

### Second Example: Characterization of the Device according to the First Example

a. Femtojoule ReLU function

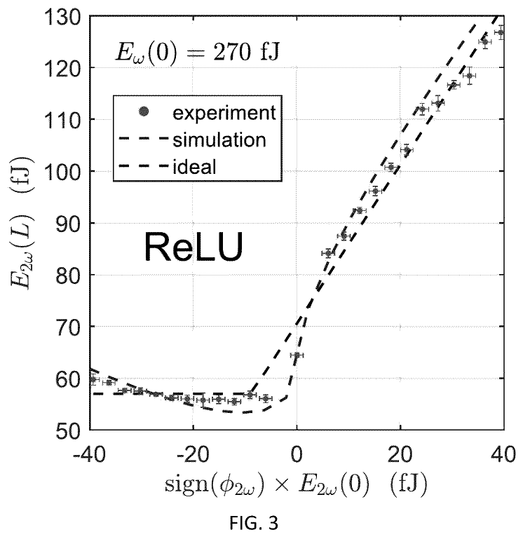

The measured response of the all-optical ReLU is shown in FIG. 3. The nonlinear function given by the PPLN was measured using a free-space chip characterization setup.

The source at 1045 nm (signal) was a Yb:fiber mode-locked laser producing 75-fs long pulses at a 250-MHz repetition rate (Menlo Systems Orange). The same laser pumped a homemade degenerate optical parametric oscillator to generate the pulses at 2090 nm (bias). The 2ω and ω pulses were coupled into and out of the PPLN using reflective objectives focused on the waveguide facets. Finally, the relative phase of the 2ω signal and ω bias was set using a delay arm, and the power varied using a tunable attenuator. See third Example for further details about the experimental setup.

The experimental results show good agreement with the ideal ReLU function (R²=0.9895), and demonstrates energy-efficient signal pulse energies in the regime of femtojoules per activation. Note that the important feature of the function is its nonlinear shape, since scaling/shifting the horizontal/vertical directions can be accomplished with linear optical transformations. In theory, the ideal ReLU function requires an arbitrarily long PPLN and low bias pulse energy. However, in practice the bias pulse energy must be chosen so as to best approximate the ReLU function given the fixed device length. Thus, there are small discrepancies around E_{2ω}(0)=0, since neither the SHG nor DOPA processes sufficiently saturate at the ultra-low energies. The maximum cutoff pulse energy is determined by the onset of supercontinuum generation from strong back-conversion processes, which undesirably degrades the pulse shape. To verify that the expected device response matches our physical picture of the operating principle, nonlinear pulse propagation simulations of the PPLN nanophotonic waveguide were performed. See Third Example for more details about the simulation methods.

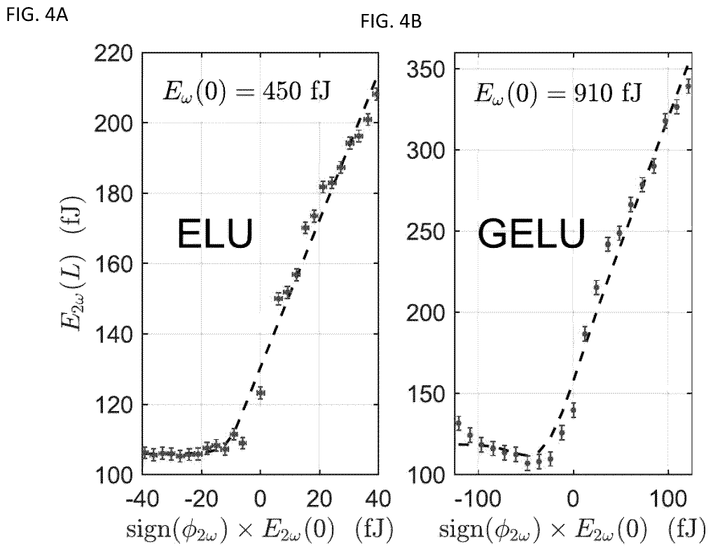

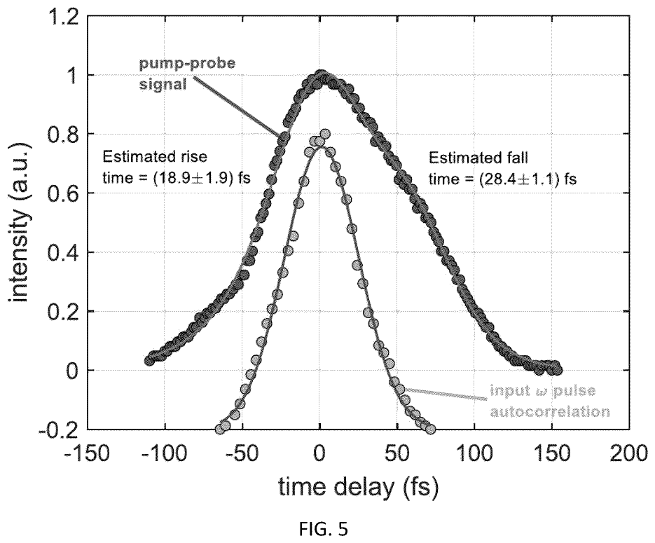

Remarkably, we shown that the PPLN nanophotonic waveguide can also approximate other commonly used variants of the ReLU function, simply by tuning the bias pulse energy. For example, the Exponential Linear Unit (ELU) defined as ELU (x)=x if x>0 and ELU (x)=exp(x)−1 if x<0, which has been shown to outperform the ReLU function in certain cases [34], is achieved using a bias pulse energy of E_{ω}(0)=450f) as shown in FIG. 4A.

Another example implementation comprises the Gaussian Error Linear Unit (GELU) defined as GELU (x)=xΦ(x) where Φ(x) is the Gaussian cumulative distribution using a bias pulse energy of E_{ω}(0)=910f] as shown in FIG. 4B. The GELU function is used extensively in Transformer networks for natural language processing, which are regularly amongst the largest deep learning models [35]. Thus, our all-optical PPLN nanophotonic waveguide implementation gains greater real-world applicability by being compatible with a wide range of existing deep learning models, especially the largest models where energy efficiency is paramount. Indeed, compatibility has been problematic in other implementations of optical [7, 17, 23-25] and optoelectronic [11,14,15,26,29] nonlinear activation functions, which do not reflect the most commonly used functions in digital electronic neural networks. By alleviating this problem, embodiments of the present invention expand the potential functionality of ONNs by avoiding the need to train new specialized models.

b. Ultrafast Time Response

Ideally, the time per activation should be near instantaneous due to the ultrafast χ⁽²⁾ nonlinearity in lithium niobate. However, in practice, the response time is limited by the finite phase-matching bandwidth as well as non-zero group velocity mismatch, group velocity dispersion, and higher-order dispersion terms. To determine the response time of the device, a pump-probe technique commonly used to characterize all-optical switches [32, 36, 37] is used (see Third Example for more details). In this case, the pump pulse is the ω pulse and the probe pulse is the 2ω pulse. The ultrafast ReLU dynamics were measured by varying the time delay between the ω and 2ω pulses at a fixed pulse energy. FIG. 5 shows the intensity envelope of the pump-probe signal as the time delay is varied as well as the autocorrelation of the input ω pulse.

The input autocorrelation is well-explained by a Gaussian profile with FWHM of (56.4±1.5) fs. The characteristic rise and fall times are extracted by fitting the pump-probe signal with exponential growth and decay functions for positive and negative time delays, respectively, convolved with the input autocorrelation. The best fit yields a rise time of (18.9±1.9) fs and a fall time of (28.4±1.1)fs. This implies that the characteristic response time of the ReLU dynamics is (47.3±3.0)fs, thus verifying that the ultrafast optical nonlinearity is responsible for the ReLU response, and ruling out the possibility of any slower optical nonlinearities such as photorefractive or thermooptic effects. Therefore, we can reasonably regard the 2ω signal pulse length of ˜75 fs as the time per activation for the all-optical ReLU. It is noted that better dispersion engineering can lead to even faster activation times.

c. Simulated Deep Learning Performance

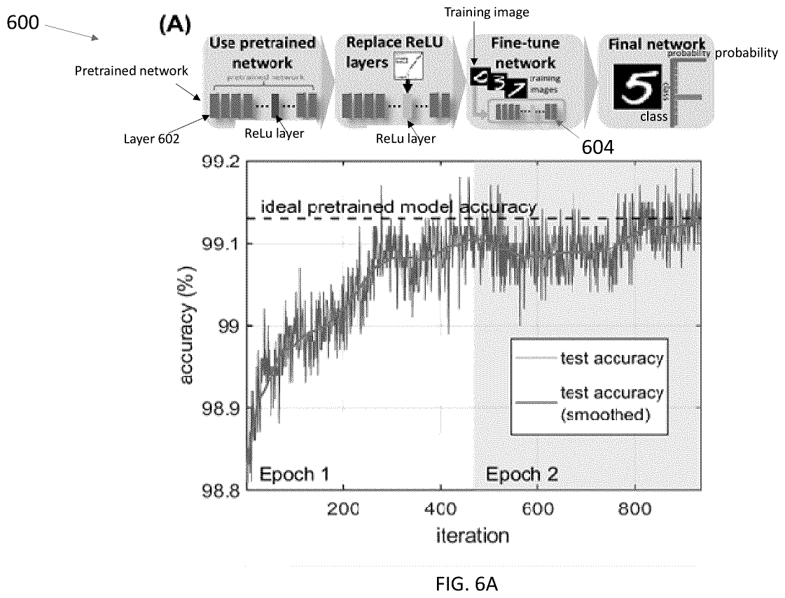

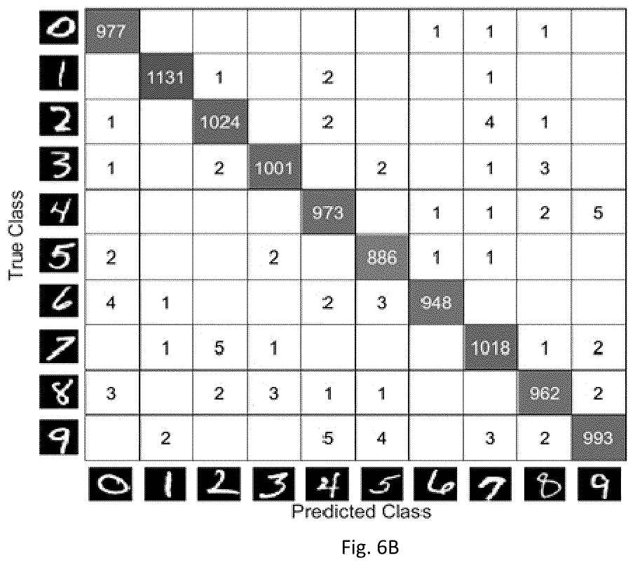

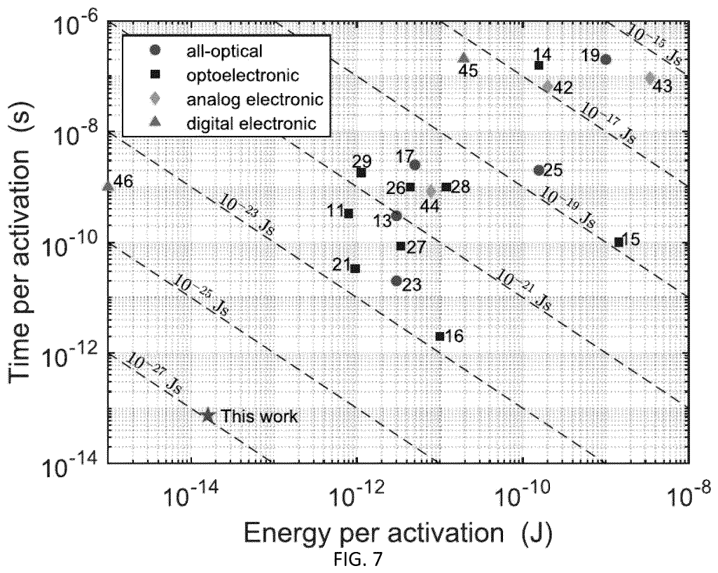

One distinct advantage of the system described here is that, unlike other all-optical [19] and optoelectronic [21] nonlinear activation functions, embodiments of the present invention can faithfully reproduce the ideal ReLU function, which uses both positive and negative values. Therefore, the large number of existing pretrained deep learning models that use the ReLU function (or its variants) can be leveraged for nonlinear activations. Although ONNs have been demonstrated that accurately reproduce linear operations such as matrix multiplication and convolution, the use of atypical nonlinear activation functions in the optical domain has required the training of new custom deep learning models [38, 39]. To improve upon this, we simulated the performance of the all-optical ReLU function when used as part of a pretrained convolutional neural network (CNN) for the prototypical task of MNIST handwritten digits image classification [40]. The MNIST dataset contains 28×28 pixels gray-scale images of handwritten digits with 50,000 training samples and 10,000 test samples. We used a standard CNN architecture (see Third example for full details) containing convolutional layers and ideal ReLU layers followed by a fully-connected layer and softmax classification output. The pretrained CNN achieved an ideal test accuracy of 99.13%. Next, the ideal ReLU layers were replaced with custom layers representing the experimentally measured ReLU response (after proper shifting/scaling) without changing any of the other layers. This caused a slight drop in test accuracy to 98.8% due to the slight deviations between the experimentally measured and ideal ReLU functions. To remedy this, the CNN was then fine-tuned by training for only 2 epochs (the CNN sees each sample once per epoch) to regain the ideal pretrained model accuracy of 99.13% as shown in FIG. 6. Fine-tuning is necessary for any analog hardware implementation due to unavoidable fabrication errors, noise and other nonidealities encountered [41]. Note that this method requires far less time compared to previous proposals for training new custom ONN models, which required>25 training epochs [38,39]. Therefore, our all-optical ReLU provides the missing link to allow ONNs to take advantage of existing pretrained models. It is noted that the softmax classification layer is yet to be faithfully implemented in an ONN which accounts for a small portion of the computation compared to the convolutions, matrix multiplications and ReLU nonlinear activations.

d. Comparison of Energy and Time Per Activation

The PPLN nanophotonic waveguide according to the first and second examples was compared to other optical [13,17,19,23], optoelectronic [11, 14-16, 21, 26-29], analog electronic [42-44], and digital electronic [45] nonlinear activation functions to demonstrate the state-of-the-art performance of the device. In this case, the appropriate figure of merit is the energy-time product, which properly accounts for both the energy consumed and time taken per activation. To quantify the energy per activation, we follow the convention in [39], as being the energy needed to generate a 50% change in the power transmission with respect to the transmission with null input. In this case, our device has an energy per activation of ˜16f]. The bias pulse energy is not included since it is not destroyed and can, at least theoretically, be reused for many signal pulses. This is because the bias pulse is not dissipated as heat, unlike the case often encountered for absorption-based processes. Assuming perfect phasematching and that positive/negative values occur equally likely, then the bias pulse should be amplified/deamplified equally likely by the processes of DOPA/SHG, respectively. The time per activation is given by the signal pulse width of ˜75 fs, owing to the near-instantaneous χ⁽²⁾ nonlinearity of lithium niobate as explained herein. Therefore, we achieve an energy-time product of 1.2×10⁻²⁷ J s. The energy and time per activation of our device is compared to other experimental demonstrations in FIG. 7.

Device-level metrics are considered wherever possible to provide a fair comparison, however, it is acknowledged that this was not always possible for nonlinear activations as part of complete networks since fan-out and cascadability constraints impose additional energy and time costs. Despite this, the outstanding metrics of our device represents a significant breakthrough for optical nonlinear activation functions. For state-of-the-art digital electronics, such as the NVIDIA A100 Tensor Core GPU [46]based on 7-nm process node [47], we generously assume that the ReLU function consumes ˜1 f] per activation, and occurs in a single 1 GHz clock cycle. We see that, although our device still has an order of magnitude greater energy per activation, the time per activation is four orders of magnitude faster. Hence, we achieve an energy-time product that is three orders of magnitude better than state-of-the-art digital electronics. Our numerical simulations (see third example) predict that the PPLN nanophotonic waveguide can realistically achieve a ReLU-like response with sub-femtojoule energy per activation. This would even surpass the energy efficiency of state-of-the-art digital electronics. We attribute the discrepancy between our experimental results and the theoretically predicted limits for the energy scale.

### Third Example: Further Information on Methods Used to Obtain the Measurements Obtained in the Second Example

a. Setup

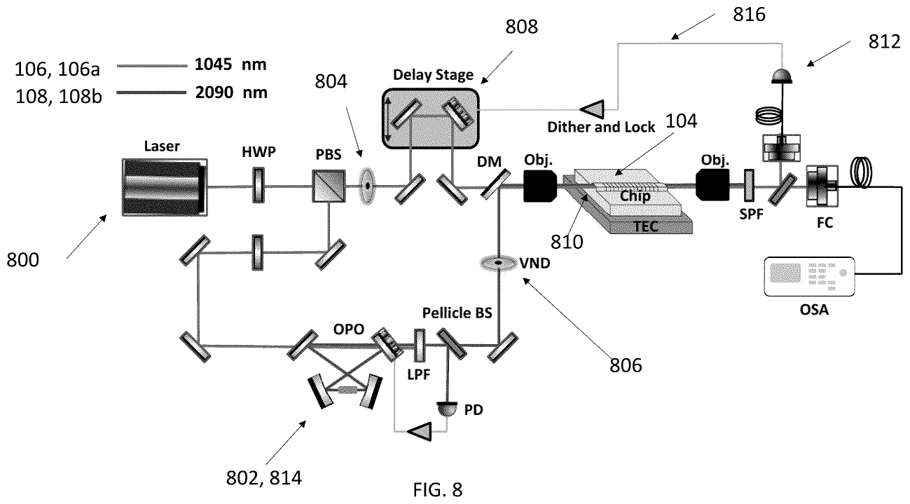

The experimental setup for the optical ReLU measurements is depicted in FIG. 8. The pump laser is a mode-locked Yb-fiber laser which provides 70 fs pulses at 1045 nm with up to 1 W average power at a 250 MHz repetition rate (Menlo Systems Orange A). The laser output is then split into two paths. The first path is sent to a synchronously pumped degenerate optical parametric (SPDOPO) oscillator based on periodically-poled lithium niobate (PPLN) which is used to efficiently generate pulses at 2090 nm [1]. The OPO is locked using a “dither and lock” scheme, facilitated by the Lock-In+PID application for Red Pitaya [2,3]. A variable ND filter is added to the output of the OPO to control the 2090 nm power sent to the device. The second 1045 nm path is sent to a delay stage. Coarse adjustment of the delay is done through manual tuning of the stage position and micrometer arm while fine adjustment is performed using a piezoelectric actuator. This delay enables temporal overlap of the two paths, and fine adjustment is used to change the relative phase of the fundamental and second harmonic for the OPA process. Like the other path, a variable ND filter is also placed along this path for adjusting the 1045 nm power. The two paths are recombined at a dichroic mirror with high transmission at 1045 nm and high reflectivity at 2090 nm before going to the device.

Focusing to and coupling from the device is done using a reflective objective (Newport 5010202). Temperature tuning of the device for fine adjustment of the quasi-phase matching condition is done using a thermoelectric cooling stage (TEC). The output of the chip is short-pass filtered around 1700 nm to remove all remaining signal at 2090 nm and then split into two paths. The signal on one path is measured with a detector and used for feedback to the delay stage. A “dither and lock” scheme, similar to that used for the OPO, is employed here to lock the relative phases of the two inputs to switch between amplification and deamplification in the OPA process [2,3]. The second path is coupled to fiber and sent to an optical spectrum analyzer (OSA) for measuring the output power and spectrum (Yokogawa AQ6370D).

b. Device Fabrication and Characterization

For the devices of the first and second examples, a wafer with 700 nm of X-cut MgO—doped LN on top of 2 μm of SiO₂ was used. 15 nm of Cr underneath 55 nm of Au were then e-beam evaporated and patterned via e-beam lithography to form poling electrodes. 300 V pulses were used to pole the chip, and the quality was confirmed using second harmonic microscopy. Waveguides were subsequently patterned on the chip using hydrogen silsesquioxane (HSQ) as the e-beam resist and 15 nm of Ti as an adhesion layer. They were dry etched with Ar⁺ plasma in an inductively-coupled plasma reactive-ion etcher (ICP-RIE), and the remaining resists and side-wall re-deposition were removed using Buffered oxide etchant (BOE) and RCA-1. Finally, the waveguide facets were mechanically polished.

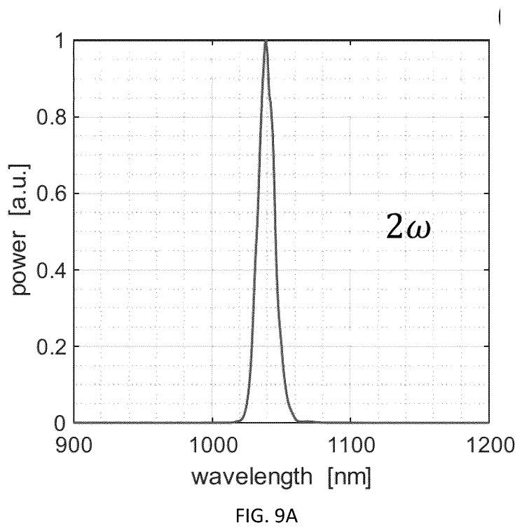

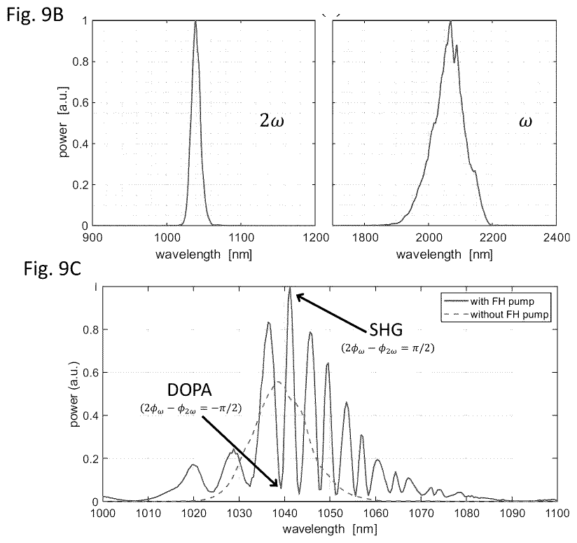

FIG. 9 displays the measured spectrums of 2ω, ω and their non-linear interaction in the waveguide. FIGS. 9A and 9B show the input spectrums of 2ω and ω, respectively and FIG. 9C shows the evolution of 2ω pulse as the phase difference is modulated. It can be seen that for the positive signal values corresponding to the phase relationship 2ϕ_{ω}−ϕ_{2ω}=π/2, the 2ω signal grows due to SHG process while depleting the ω pulse. On the other hand, for the phase relationship 2ϕ_{ω}−ϕ_{2ω}=−π/2, the ω pulse grows due to optical parametric amplification, thereby depleting the 2ω as evident from the dip in the spectrum.

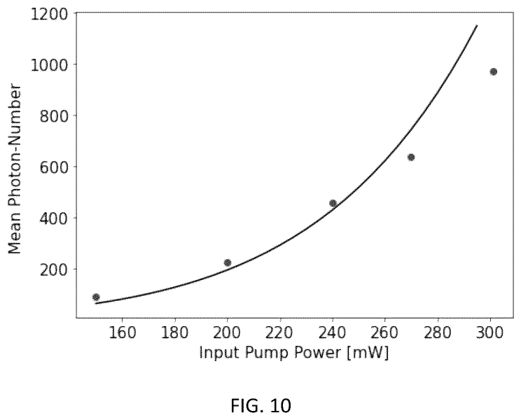

The input and output coupling efficiencies of the device were estimated. A detailed discussion is provided in other work on optical parametric generation (OPG) and amplification (OPA) [4, 5]; here we outline the main steps. For a degenerate OPG process in the high parametric gain regime, the generated average photon-number in an ideal case is given by

$$〈 N 〉 \approx \frac{1}{4} {e}^{2 L \sqrt{η P}} ,$$

where P, L and η are pump power, interaction length, and non-linear interaction efficiency. In the presence of experimental imperfections such as off-chip coupling, coupling to optical fibers, and detection inefficiencies, the average photon-number is given as

$$〈 N 〉 \approx \frac{{η}_{1}}{4} {e}^{2 L \sqrt{{η}_{2} P}} ,$$

where all optical losses on the OPG signal are combined in η₁ parameter and η₂ quantifies the non-linear interaction strength and the input coupling efficiency of our second harmonic signal. From the measured data for OPG power, the average photon number for various values of the second harmonic pump is determined. By fitting the data, the η₁ and η₂ parameters are extracted. In FIG. 10, the measured average number of photons are displayed with respect to the input pump power. From the fit, we extract η1≈0.20, i.e., the estimated output coupling loss is about 7 dB, which shows a good agreement with [4,5]. Given the total coupling loss measured at low power, the input coupling loss is then determined as the difference between total and output coupling losses. It is noted note that coupling losses<1 dB per facet have been reported for thin-film lithium niobate photonics [6], which is promising for large-scale circuits.
c. Simulation Method

We numerically solved an analytical nonlinear envelope equation (NEE) in the frequency domain using a split-step Fourier technique to simulate the pulse propagation and nonlinear dynamics in the waveguide. The nonlinear step was implemented using fourth-order Runge-Kutta method. The NEE was obtained by ignoring counter-propagating modes, which are usually phase mismatched, and assuming a constant nonlinear coefficient across the entire simulation bandwidth. The fundamental and second harmonic pulses were assumed to have a transform-limited, hyperbolic-secant profile. The NEE is given by:

$$\frac{\partial A}{\partial z} = - i [ β ( ω ) - {β}_{0} - \frac{Ω}{{v}_{r e f}} - i \frac{α}{2} ] A - \frac{i ω {ε}_{0} {X}_{0}}{8} d ( z ) {ℱ}_{Ω} \{ {a}^{2} ( z , t ) {e}^{j ϕ ( z , t )} + 2 a ( z , t ) {a}^{*} ( z , t ) {e}^{- j ϕ ( z , t )} \} ,$$

where A(z, ω) is the complex amplitude of the field during propagation, a(z, t) is the time domain representation of A(z, Ω),ϕ(z, t)=ω₀t−(β₀−ω0/ν_{ref})z,β₀ is the waveguide propagation constant at frequency ω₀, Ω=ω−ω₀ is the envelope frequency, ω is the optical frequency, α is the attenuation constant, d(z)=±1 is the instantaneous sign of the nonlinear coefficient due to quasi-phase matching, F_{Ω} is the Fourier transform in Ω, and χ₀ is the effective nonlinear coefficient.

To simulate the ReLU response of our experimental device, shown in FIG. 3 in the main text, we assumed α≈0.1 dB/cm and used the following waveguide geometry obtained from atomic force microscope measurements: waveguide top width of 1768 nm, ridge height (etch depth) of 377 nm, and a total lithium niobate thin-film thickness (before etching) of 713 nm. We use the effective nonlinear coefficient as a fitting parameter to match the experimental data and inferred a value of χ₀≈0.36×10⁻¹²V², which is about ˜⅓ of its ideal value.

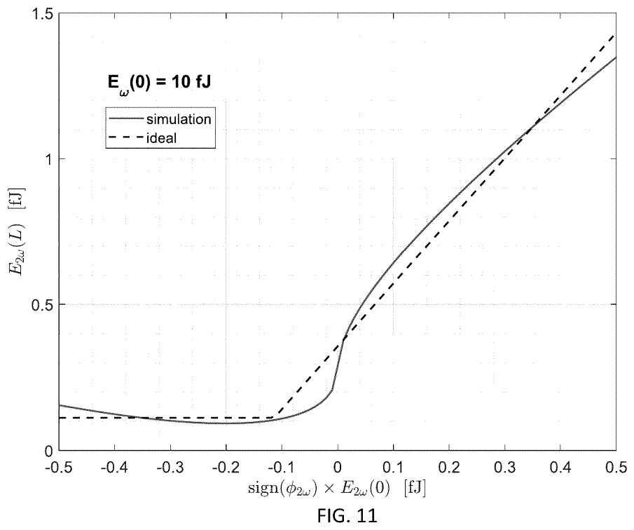

Given the fabrication error and imperfect phase-matching of our device, experimentally achieved an energy of ˜16f] per activation. However, FIG. 11 shows the simulated ideal performance of a PPLN with length L=2.5 mm, ridge top width of w=1700 nm, etch-depth of h=350 nm, and bias pulse energy of E_{ω}(0)=10f]. We see that it can achieve a ReLU-like function with sub-femtojoule energy per activation.

d. Fitting of Pump-Probe Signal

The input autocorrelation was fit using a Gaussian profile:

$$G ( t ) = \frac{1}{σ \sqrt{2 π}} {e}^{\frac{- {t}^{2}}{2 {σ}^{2}}}$$

where σ is related to the FWHM by FWHM=2π\sqrt{2ln 2}. The exponential function with characteristic decay time of τ=1/λ is defined as:

$$F ( t ) = {e}^{- λ t} .$$

The convolution between G(t) and F(t) is defined as:

$$I ( {t}^{′} ) = F ( t ) * G ( t ) = \frac{1}{σ \sqrt{2 π}} {\int }_{0}^{∞} {e}^{- λ t} {e}^{- \frac{{( {t}^{′} - t )}^{2}}{2 {σ}^{2}}} d t$$

The pump-probe signal was fitted with exponential growth and decay functions for positive and negative time delays, respectively, convolved with the input autocorrelation by using the analytical formula for Eq. S6:

$$I ( {t}^{′} ) = \frac{1}{2} {e}^{- λ ( {t}^{′} - {σ}^{2} λ / 2 )} [ 1 + erf ( \frac{{t}^{′} - {σ}^{2} λ}{\sqrt{2} σ} ) ]$$

where

$$erf ( x ) = \frac{2}{\sqrt{π}} {\int }_{0}^{x} {e}^{- {z}^{2}} d z$$

is the error function.

### Fourth Example: Network Architecture

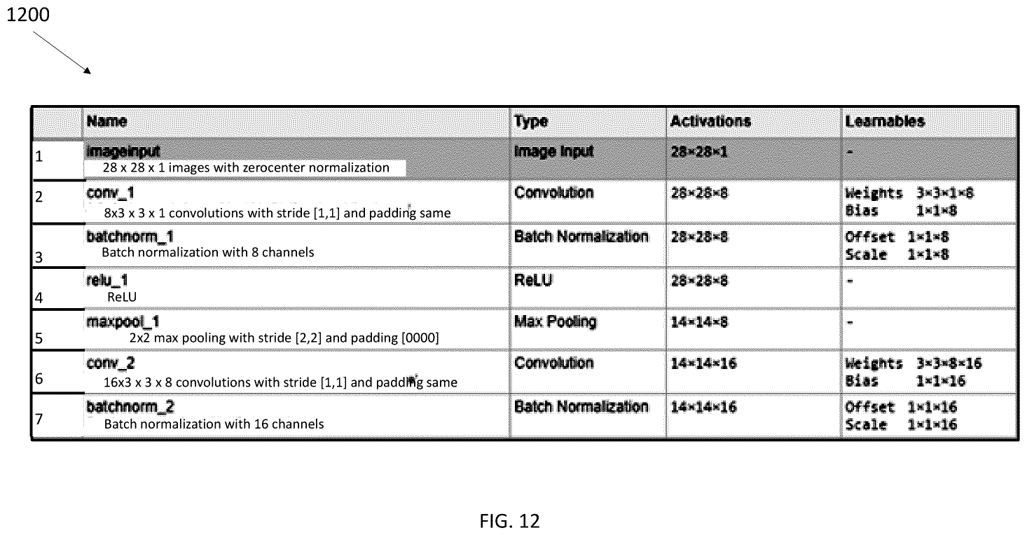

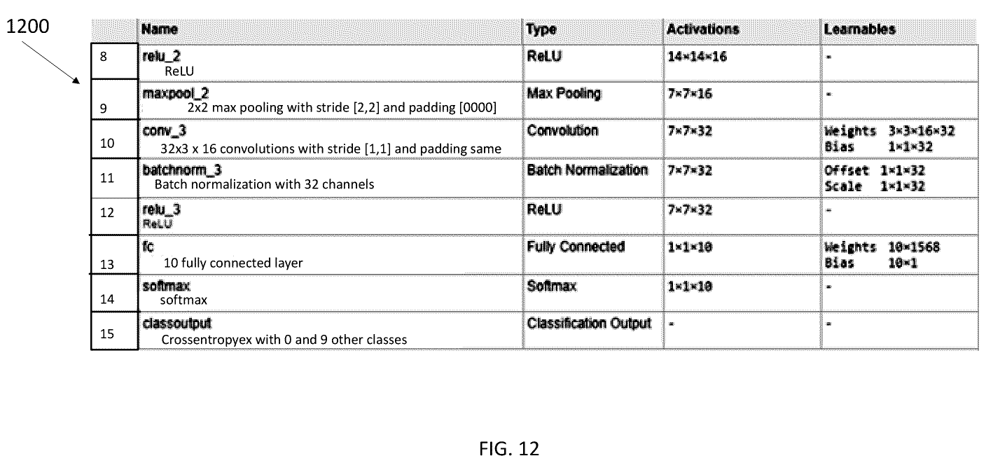

The nonlinear activation function according to the present invention can be integrated into a complete ONN architecture. An example pretrained convolutional neural network (CNN) architecture is shown in FIGS. 6 and 12. The CNN was trained on the MNIST handwritten digits image classification [7] using stochastic gradient descent with momentum (SGDM) with initial learn rate of 0.01 and batch size of 128. For fine-tuning after the ideal ReLU layers were replaced with custom layers representing the experimentally measured ReLU response, the initial learn rate was decreased to 0.001.

### Fifth Example: Integrated Photonic Neural Networks

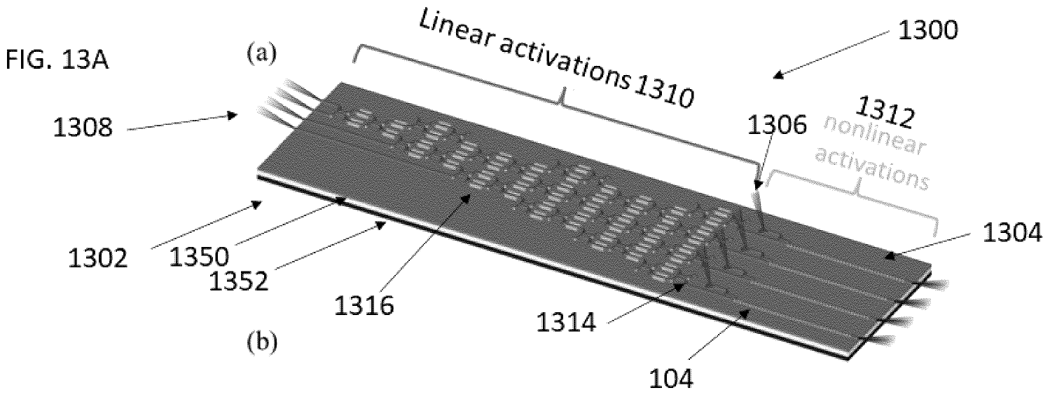

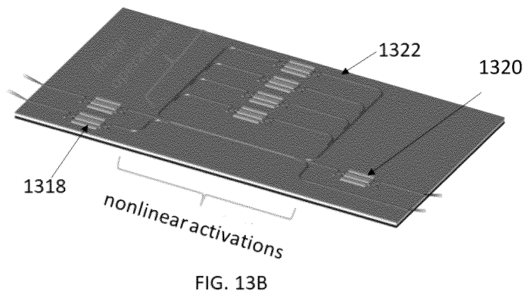

Methods for integration of the all-optical ultrafast ReLU into a complete ONN include monolithic integration with high-speed electro-optic modulators in thin-film lithium niobate nanophotonic circuits. One example design, shown in FIG. 13A, implements spatial multiplexing using a mesh of MachZehnder inteferometers, akin to those demonstrated in silicon photonics [8], to perform linear operations, directly followed by an array of PPLNs to perform the ReLU activations. Therefore, in this example, each neuron represents a separate PPLN and the entire neural network layer is computed in a constant time step. Subsequent layers are identical in structure and can be directly cascaded following the array of PPLNs. The bias pulse can be directly fed to each PPLN using out-of-plane couplers as shown in FIG. 13A, or by using in-plane photonic crossbar switches. The bias and signal pulses can be decoupled using wavelength-division multiplexing (WDM) filters either on-chip or off-chip.

A second method, shown in FIG. 13B, uses a time-multiplexed technique based on a single photonic neuron folded in time with feedback-modulated delay loops [9]. In this architecture, each delay loop at each time step represents a different synaptic connection in the neural network layer. By properly updating the feedback modulators at each time step, the required linear operations can be achieved. Therefore, only one PPLN performing ReLU activations is needed to represent all neurons, but the number of delay loops and time steps to compute each neural network layer equals the number of synapses for each neuron. This architecture may be advantageous in that it relaxes the experimental constraints for fabricating and controlling a large number of PPLNs like in the spatially-multiplexed method.

Given the relatively long (˜mm) length of the PPLN, but ultrafast response time, it is desirable to employ a time-multiplexed approach for scalability. Furthermore, although the use of free-space coupling is shown here, this can be eliminated through the monolithic integration of thin-film lithium niobate lasers [10], and integrated detectors [11]. Implementation of the circuits of FIGS. 13A and 13B could be achieved by adaptation of the processing technologies demonstrated thin-film lithium niobate photonic circuits [4, 12-14], Furthermore, a monolithically integrated photonic neural network could be achieved using improved fabrication quality/tolerance in thin-film lithium niobate photonics.

### Sixth Example: Processing Environment

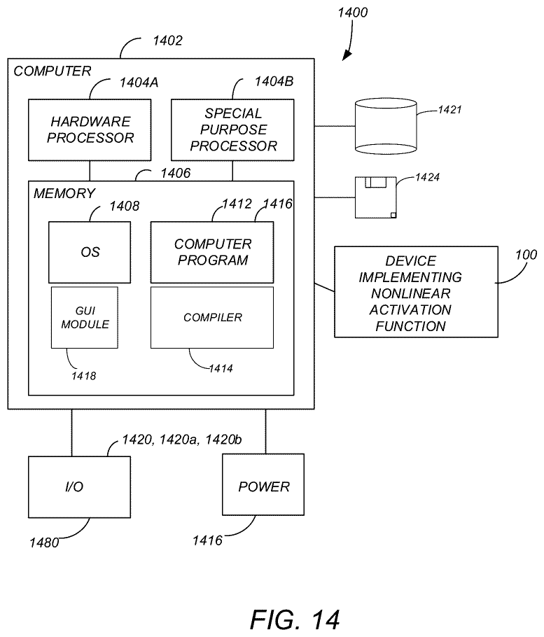

FIG. 14 illustrates an exemplary system 1400 comprising a computer 1402 used to implement processing elements needed to control the device comprising the photonic waveguide or photonic integrated circuit described herein. Computer 1402 may be a user/client computer, server computer, or application specific integrated circuit (ASIC), for example, or parallel processing system or distributed/cloud-based computer system 1000 using a network 1004 to connect one or more client computers 1402 to one or more server computers.

The computer 1402 comprises a hardware processor 1404A and/or a special purpose (hardware) processor 1404B (hereinafter alternatively collectively referred to as processor) and a memory 1406, such as random access memory (RAM). Generally, the computer 1402 operates under control of an operating system 1408 stored in the memory 1406, and interfaces with the user/other computers to accept inputs and commands (e.g., analog or digital signals) and to present results (outputs from the device) through an input/output (I/O) module 1480 or devices. In one or more examples, I/O module comprises a display, graphics user interface (GUI), a keyboard, or a pointing/cursor control device (e.g., mouse). Output/results may be presented on the display or provided to another device for presentation or further processing or action. An image may be provided through a GUI module 1418, for example. Although the GUI module 1418 is depicted as a separate module, the instructions performing the GUI functions can be resident or distributed in the operating system 1408, the computer program 1410, or implemented with special purpose memory and processors.

In one embodiment, the computer 1402 operates by the hardware processor 1404A performing instructions defined by the computer program 1412 under control of the operating system 1408. The computer program application 1412 accesses and manipulates data stored in the memory 1406 of the computer 1402. The computer program 1412 and/or the operating system 1408 may be stored in the memory 1406 and may interface with the user and/or other devices to accept input and commands and, based on such input and commands and the instructions defined by the computer program 1412 and operating system 1408, to provide output and results.

Some or all of the operations performed by the computer 1402 according to the computer program 1412 instructions may be implemented in a special purpose processor 1404B. In this embodiment, some or all of the computer program 1412 instructions may be implemented via firmware instructions stored in a read only memory (ROM), a programmable read only memory (PROM) or flash memory within the special purpose processor 1404B or in memory 1406. The special purpose processor 1404B may also be hardwired through circuit design to perform some or all of the operations to implement the present invention. Further, the special purpose processor 1404B may be a hybrid processor, which includes dedicated circuitry for performing a subset of functions, and other circuits for performing more general functions such as responding to computer program 1412 instructions. In one embodiment, the special purpose processor 1404B is an application specific integrated circuit (ASIC) or Field Programmable Gate Array (FPGA).

The computer 1402 may also implement a compiler 1414 that allows an application or computer program 1412 written in a programming language such as C, C++, Assembly, SQL, PYTHON, PROLOG, MATLAB, RUBY, RAILS, HASKELL, or other language to be translated into processor 1404 readable code. Alternatively, the compiler 1414 may be an interpreter that executes instructions/source code directly, translates source code into an intermediate representation that is executed, or that executes stored precompiled code. Such source code may be written in a variety of programming languages such as JAVA, JAVASCRIPT, PERL, BASIC, etc. After completion, the application or computer program 1412 accesses and manipulates data accepted from I/O devices and stored in the memory 1406 of the computer 1402 using the relationships and logic that were generated using the compiler 1414.

The computer 1402 also optionally comprises an external communication device such as a modem, satellite link, Ethernet card, or other device for accepting input from, and providing output to, other computers 1402.

In one embodiment, instructions implementing the operating system 1408, the computer program 1412, and the compiler 1414 are tangibly embodied in a non-transitory computer-readable medium, e.g., data storage device 1421, which could include one or more fixed or removable data storage devices, such as a zip drive, floppy disc drive, hard drive, CD-ROM drive, tape drive, etc. Further, the operating system 1408 and the computer program 1412 are comprised of computer program 1412 instructions which, when accessed, read and executed by the computer 1402, cause the computer 1402 to perform the steps necessary to implement and/or use the present invention or to load the program of instructions into a memory 1406, thus creating a special purpose data structure causing the computer 1402 to operate as a specially programmed computer executing the method steps described herein. Computer program 1412 and/or operating instructions may also be tangibly embodied in memory 1406 and/or data communications devices 1430, thereby making a computer program product or article of manufacture according to the invention. As such, the terms “article of manufacture,” “program storage device,” and “computer program product,” as used herein, are intended to encompass a computer program accessible from any computer readable device or media In one or more examples, a computer program product comprises a computer readable storage medium 1424 having program instructions embodied therewith, the program instructions executable by one or more computers 1402 to cause the computers to perform a method comprising controlling the device (e.g., controlling the bias wave and bias signals).

Those skilled in the art will recognize many modifications may be made to this configuration without departing from the scope of the present disclosure. For example, those skilled in the art will recognize that any combination of the above components, or any number of different components, peripherals, and other devices, may be used.

### Seventh Example: Process and Device Embodiments

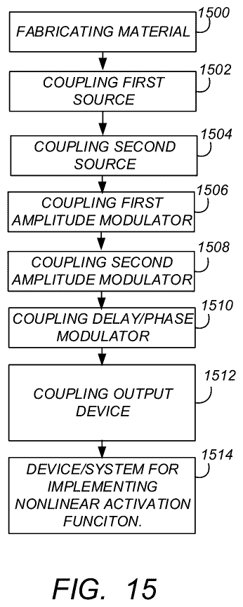

FIG. 15 is a flowchart illustrating a method of making a device

Block 1500 represents fabricating a (e.g., nonlinear) material comprising a (e.g., spatially varying dielectric) second order nonlinear susceptibility phase-matching a coherent (e.g., second-order) nonlinear interaction involving a signal (e.g. signal wave) comprising a signal wavelength and a bias (e.g., bias wave) comprising a bias wavelength, so that:
a first phase difference between the signal wave and the bias wave induces the interaction comprising second harmonic generation, generating a second harmonic of the bias wave or sum frequency generation generating a sum frequency of the bias wave and the signal wave, and
a second phase difference between the signal wave and the bias wave induces the interaction comprising (e.g., optical) parametric amplification (comprising degenerate or non-degenerate optical parametric amplification) amplifying the bias wave and attenuating the signal wave;

The step further comprises providing an input 152 to the nonlinear activation function for inputting a positive input comprising the signal wave having an input energy and a first phase difference, or a negative input comprising the second phase difference.

The step further comprises providing an output 150 from the nonlinear activation function, for outputting an output signal in response to the input, the output signal comprising an output energy of the signal wave outputted from the material or photonic waveguide (comprising the material) as a function of the input energy of the signal wave inputted to the material/photonic waveguide.

In one or more examples, the (e.g., nonlinear) material is patterned on a substrate to form a waveguides configured in a photonic integrated circuit. In one or more examples, the substrate 1302 comprises lithium niobate 104 on silica 1350 on silicon 1352, and the waveguides are patterned in the lithium niobate (e.g., monolithic integration of the waveguides).

Block 1502 represents optionally coupling the device to a first source outputting the signal wave.

Block 1504 represents optionally coupling a second source outputting the bias wave.

Block 1506 represents coupling a first amplitude modulator modulating the input energy of the signal wave inputted to the (e.g., nonlinear) material.

Block 1508 represents optionally coupling a second amplitude modulator modulating an energy of the bias wave inputted to the (e.g., nonlinear) material.

Block 1510 represents optionally coupling a delay line or a phase modulator in a path transmitting the signal wave from the first source to the input to the (e. g, nonlinear) material, wherein the delay line or phase modulator sets the first phase difference or the second phase difference.

Block 1512 represents optionally coupling an output device. In one example, the output device comprises a detector coupled to an output of the material or photonic waveguide comprising the nonlinear material, for measuring the output energy of the signal wave and outputting a detection signal in response thereto.

Block 1514 represents the end result, a device (or system comprising the device) for implementing the nonlinear activation function.

Example devices and systems according to the present invention include, but are not limited to, the following (referring also to FIGS. 1-14)
1. A device 100 for implementing a nonlinear activation function 102, comprising:
   a (e.g., nonlinear) material 104 or medium comprising (e.g., a spatially varying dielectric) second-order nonlinear susceptibility phase-matching a coherent (e.g., second-order) nonlinear interaction involving a signal 106 (e.g. signal wave 2ω) comprising a signal wavelength and a bias 108 (e.g., bias wave ω) comprising a bias wavelength, so that:
   a first phase difference (e.g., 2ϕ_{ω}−ϕ_{2ω}) between the signal wave and the bias wave induces the interaction comprising second harmonic generation (generating a second harmonic 2ω, 110 of the bias wave) or sum frequency generation (generating a sum frequency of the bias wave and the signal wave), and
   a second phase difference (e.g., 2ϕ_{ω}−ϕ_{2ω}) between the signal wave and the bias wave induces the interaction comprising parametric amplification 112 (e.g., degenerate or non-degenerate optical parametric amplification) amplifying the bias (e.g., bias wave ω) and attenuating the signal (e.g., signal wave 2ω).

The input 152 to the nonlinear activation function comprises or receives a positive input 114 comprising the signal 106 having an input energy and the first phase difference or a negative input 116 comprising the second phase difference. The output 150 from the nonlinear activation function or the material 104, in response to the input, comprises an output energy of the signal 106 outputted from the nonlinear material 104 as a function of the input energy of the signal inputted to the nonlinear material 104.
2. The device of example 1, further comprising one or more photonic (e.g. nanophotonic) waveguides 118 each comprising the (e.g., nonlinear) material 104, the waveguide having a thickness h or h+t on the order of the signal wavelength so as to confine and guide the signal wave along the waveguide. In one or more examples, a width w and/or height h (or h+t) of the photonic waveguide 118 is in a range of 10 nm-1000 micrometers (see e.g., FIG. 2).
3. The device of example 1 or 2, wherein the (e.g., nonlinear) material 112 comprises lithium niobate, lithium tantalate, Potassium Titanyl Phosphate (KTP), aluminum nitride, gallium arsenide, indium phosphide, or aluminum gallium arsenide.
4. The device of any of the examples 1-3, wherein the material 104 comprises a periodically poled ferromagnetic material 202 or an orientation of the nonlinear susceptibility patterned along a length of the nonlinear material.
5. The device of any of the examples 1 or 3-4, wherein:
   the material 104 comprises at least one bulk component selected from a fiber coupled nonlinear waveguide or bulk crystal, and the input optionally comprises a gaussian beam. The bias and signal can be coupled through free space or through fibers or input couplers, for example.
6. The device of any of the examples 1-5, wherein the signal comprises the second harmonic of the bias, the first phase difference is

$$π / 2 ( e . g , 2 {ϕ}_{ω} - {ϕ}_{2 ω} = \frac{π}{2} ) ,$$

and the second phase difference is

$$- π / 2 ( e . g . , 2 {ϕ}_{ω} - {ϕ}_{2 ω} = - π / 2 ) .$$

7. A photonic integrated circuit 1300 comprising the device of any of the examples 1-4 or 6 further comprising:
   a chip substrate 1302;
   the material 104 (e.g., one or more waveguides 1304 comprising the nonlinear material 104) on the chip substrate;
   the input 152a comprising one or more bias input couplers 1306, each of the bias input couplers coupling the bias (e.g., bias wave) into a different one of the photonic waveguides; and
   the input 152b comprising one or more signal input couplers 1308, each of the signal input couplers coupling the signal (e.g., signal wave) into a different one of the waveguides.
8. The photonic circuit 1300 of any of example 7, further comprising a first circuit or layer 1310 performing linear operations (e.g., addition, subtraction, multiplication, matrix operations, convolution, storing of particular weights for the bias) and a second circuit or layer 1312 comprising the material 104 performing the nonlinear activation functions, wherein outputs 1314 of the first circuits comprise the signal(s) (e.g., signal waves) inputted into the photonic waveguides of the second circuit.
9. The photonic circuit of example 8, wherein the first circuit comprises Mach Zehnder interferometers 1316 each having a pair of arms 1318 and an electrooptic modulator 1320 couples to a least one of the arms so as to modulate a phase of the signal wave in at least one of the arms.
10. A system comprising an application specific integrated circuit (ASIC) or a field programmable gate array (FPGA) coupled to the electrooptical modulator in example 9, wherein the electrooptical modulator modulate the phase according to radio frequency signals received from the ASIC or the FPGA.
11. The photonic circuit 1300 of any of the examples 7-10, further comprising:
   one or more feedback loops 1322 between the output of each of the photonic waveguides and the input 152 of the each of the photonic waveguides 1304, wherein each of the feedback loops performs a linear operation 1310 (e.g. addition, multiplication, matrix operations, storing of weights for the bias) and each feedback loop comprises a modulator (e.g., electrooptic modulator 1320) for controlling addressing each of the feedback loops at a different time step in a time-multiplexed configuration (see e.g., FIG. 13B). The feedback loops can be updated in real time and may comprising a coherent Ising machine.
12. A system comprising the device of any of the examples 1-11, further comprising:
   a first source 800 outputting the signal (e.g., signal wave) or electromagnetic radiation used to form the signal;
   a second source 802 outputting the bias wave or electromagnetic radiation used to form the bias;
   a first amplitude modulator 804 modulating the input energy of the signal (e.g., signal wave);
   a second amplitude modulator 806 modulating an energy of the bias (e.g., bias wave);
   a delay line 808 or a phase modulator in a path transmitting the signal from the first source 800 to the input 810 to the material 104 (or photonic waveguide), wherein the delay line 808 or phase modulator sets the first phase difference or the second phase difference; and
   a detector 812 or output device (e.g., output circuit or layer) coupled to an output 150 of the photonic waveguide for (1) measuring the output energy of the signal 106 and outputting a detection signal in response thereto or (2) receiving the output.
13. The system of example 12, further comprising a computer 1400:
   outputting control signals to at least one of the first source, the second source, the first amplitude modulator, the second amplitude modulator, the delay line or the phase modulator, wherein the control signals control the input energy and set the first phase difference and the second phase difference; and
   receiving the detection signal or the output.
13. The system of example 13, wherein the computer 1400 comprises at least one of a field programmable gate array or an application specific integrated circuit outputting the control signals.
14. The system of any of the examples 12-13, wherein the detector detects the output comprising an analog (continuous) output.
15. The system of any of the examples 12-14, wherein:
   the first source comprises a first laser outputting first electromagnetic radiation 106a comprising the signal or used to form the signal (e.g., via modulation); and
   the second source comprises a second laser outputting second electromagnetic radiation 108b comprising the bias or used to form the bias (e.g., via modulation), wherein the first laser and the second laser are coherently coupled so that the first electromagnetic radiation is coherent with the second electromagnetic radiation.
16. The system of any of the examples 12-14, wherein the second source comprises a frequency modulator 814 modulating the signal wavelength of the signal (e.g., signal wave) so as to form the bias (e.g., bias wave).
17. The system of example 16, wherein the frequency modulator comprises a half harmonic generator or an optical parametric oscillator.
18. The system of any of the examples 12-17, further comprising a feedback 816 between the detector or the output device and the delay line or the phase modulator for locking the first phase difference or the second phase difference.
19. The device of any of the examples 1-18, wherein the response of the nonlinear activation function is determined by an energy of the bias wave.
20. The device of any of the examples 1-19, wherein the nonlinear activation function comprises a RELU function, an ELU function, or a GELU function, or any other nonlinear activation function resulting from different energies of the bias (e.g., bias wave), or a nonlinear activation function resulting from pump depleted second harmonic generation in the absence of the bias (e.g., bias wave).
21. The device of any of the examples 1-20, wherein the phase matching is such that the nonlinear activation function is implemented with pulses of the signal (e.g., signal wave) each having the input energy less than:
   100 femtojoules and pulses of the bias (e.g., bias wave) each having an energy less than 100 femtojoules and a duration of less than 100 femtoseconds, or
   1000 picojoules and the pulses of the bias (e.g., bias wave) each having an energy of less than 1000 picojoules and the duration of less than 1000 picoseconds.
22. An optical neural network 600, 1200 comprising the device of any of the examples 1-21, wherein the optical neural network implements machine learning or deep learning.
23. The method or device of any of the examples, wherein the phase matching is type I (quasi phase matching) or type II phase matching.
24. The method or device of any of the examples, wherein the signal and the bias each comprise one or more waves and/or fields (e.g., electromagnetic waves or fields), e.g., having a wavelength in a range of 400 nm-10 microns.
26. The method of any of the examples, wherein the material 104 comprises periodically poled lithium niobate nanophotonic waveguides achieving ultra-low energies in the regime of femtojoules per activation with near-instantaneous (real time) operation, which can be used in ab all-optical, energy-efficient photonic deep learning application.
27. The method or device of any of the examples, wherein the nonlinear activation function is a Rectified Linear Unit (ReLU) function, defined as ReLU (x)=max(0, x).
28. The method or device of any of the examples, wherein the signal 106 comprises a signal wave and the bias 108 comprises a signal wave.

### Method of Operating

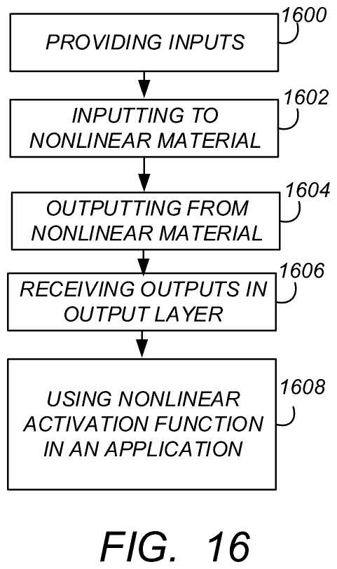

FIG. 16 illustrates a method of implementing a nonlinear activation function (e.g, using the device of any of the examples 1-28 above or described herein).

Block 1600 represents providing or obtaining one or more inputs or one or more input layers outputting one or more signal waves and one or more bias waves.

In one example, the signal (e.g., signal waves) are provided from one or more input layers performing linear operations. The input layers can be coupled to the photonic waveguides using spatial multiplexing or time division multiplexing.

In another example, the nonlinear activation function is connected to a neural network comprising the one or more input layers 602 providing the signal (e.g., waves and the bias (e.g., waves).

Block 1602 represents inputting the one or more signal waves and the one or more bias waves to one or more photonic waveguides each comprising a (e.g., nonlinear) material comprising (e.g, a spatially varying dielectric) second order nonlinear susceptibility phase-matching a coherent second-order nonlinear interaction involving a signal comprising a signal wavelength and a bias comprising a bias wavelength, wherein:
a first phase difference (e.g., 2ϕ_{ω}−ϕ_{2ω}) between the signal and the bias induces the interaction comprising second harmonic generation 110, generating a second harmonic of the bias 2ω or sum frequency generation generating a sum frequency of the bias and the signal,
a second phase difference (e.g., 2ϕ_{ω}−ϕ_{2ω}) between the signal and the bias induces the interaction comprising (e.g., optical) parametric amplification 112 (comprising degenerate or non-degenerate optical parametric amplification) amplifying the bias and attenuating the signal; and
the input to the nonlinear activation function comprises a positive input comprising the signal having an input energy and the first phase difference or a negative input comprising the second phase difference.

Block 1604 represents outputting one or more outputs from the nonlinear activation functions in response to the inputs, the outputs each comprising an output energy of the signal outputted from the photonic waveguide as a function of the input energy of the signal inputted to the photonic waveguide.

Block 1606 represents outputting the outputs to one or more output layers or output devices or circuits. In an example wherein the nonlinear activation function is in a layer of a neural network 600, the outputs are outputted to another one of the layers 604 in the neural network.

Block 1608 represents optionally utilizing the nonlinear activation function in an application. In one example, the step comprises training a neural network (comprising the nonlinear activation function) using training data, to obtain a trained neural network, and using the trained neural network to analyze new data.

### Advantages and Improvements

Deep neural networks require two major types of computations: (1) linear operations in the form of matrix multiplications and convolutions, which represent the synaptic connections of the network, and (2) nonlinear activation functions, which represent the neuron activations. Although (optical neural networks) ONNs excel at performing energy-efficient linear operations in the optical domain, a major remaining roadblock is achieving scalable energy-efficient nonlinear activation functions. The majority of ONN implementations still opt to utilize electronics to perform the nonlinear activation functions. In doing so, the optoelectronic conversion typically imposes significant speed and energy limitations. On the other hand, the conventionally demonstrated all-optical approaches based on various processes are still too energy-intensive and/or slow compared to electronics. This is because photon-photon interactions are typically weak and require either high light intensities or high-Q resonant cavities, both of which are undesirable for scalable computing purposes.

The widespread adoption of the ReLU function was essential in sparking the deep learning revolution due to its favorable properties for backpropagation training and simple implementation in digital electronics [1]. However, its optical implementation has remained challenging and posed a major hurdle for the real-world applicability of ONNs.

The present disclosure, on the other hand, has demonstrated an all-optical ultrafast ReLU function using a PPLN nanophotonic waveguide. It has an energy per activation of ˜16f] and time per activation of ˜75 fs, thus achieving a state-of-the-art energy-time product of 1.2×10⁻²⁷ J s.

Furthermore, the present disclosure demonstrated how the same device can be used to implement other common variants of the ReLU function, and showed how it can exploit existing pretrained deep learning models to greatly reduce training time. Given the rapid improvements in scalability of thin-film lithium niobate photonics, a device according to embodiments described herein could be used to replace periphery digital electronic circuits for calculating nonlinear activations in ONNs. Therefore, disclosed herein is a clear and practical path towards truly all-optical, energy-efficient photonic deep learning.

Indeed, in addition to demonstrating how PPLN nanophotonic waveguides can implement all-optical, ultrafast, energy efficient nonlinear activation functions in a building block of a full neuron, the present invention further demonstrates implementation in a complete ONN architecture. Interestingly, DOPA and SHG are theoretically noiseless amplification/deamplification processes. Therefore, the all-optical ReLU function should not contribute additional noise to a photonic neural network. In principle, the all-optical ReLU is compatible with most existing ONN architectures that can accurately implement linear operations such as matrix multiplication and convolutions. However, in practice, the speed bottleneck will likely be the encoding of information into the required coherent optical amplitudes. In this case, PPLN nanophotonic waveguides can be monolithically integrated with high-speed electro-optic modulators in thin-film lithium niobate, demonstrated to achieve bandwidths beyond 100 GHz [49]. Furthermore, the light sources can also be integrated on-chip using thin-film lithium niobate optical parametric oscillators [50]. Therefore, all the fundamental building blocks needed for a complete ONN in thin-film lithium niobate already exist.

Given the rapid increases in scalability of thin-film lithium niobate photonics, we are confident that a complete ONN can be demonstrated. One approach is to use Mach-Zehnder interferometer meshes [18] or photonic tensor cores with waveguide cross-bar arrays [20] to implement the linear matrix multiplications, then cascaded into PPLN nanophotonic waveguides to perform nonlinear activations. Another method is to use a time-multiplexed architecture similar to ones demonstrated for coherent Ising machines [51] or photonic reservoir computers [14,15]. See the fifth example for more detailed descriptions and schematics of integrated lithium niobate nanophotonic neural networks for deep learning.

A valid concern is harnessing the full capabilities of the all-optical ReLU function. It is challenging to fully exploit the ultrafast time response of the nonlinear optical processes since current interfacing electronics is currently limited to GHz bandwidths [48]. However, this should not automatically preclude the use of ultrafast nonlinear optics for optical computing. For example, coherent Ising machines [51] and optical signal processing [52], which require optical input and optical output, are prime candidates for near-term applications. In the future, all-optical computing hardware using such parametric ultrafast nonlinear activation functions may operate with THz clock rates. Crucially, the all-optical ReLU is cascadable since DOPA/SHG are inherently energy-conserving, i.e. the output is sufficiently energetic to serve as the input trigger for at least one other neuron. If multiple outputs are desired, i.e. fan-out, then intermediate amplification is needed, which can be provided by the same type of PPLNs demonstrated. Therefore, in principle, the bottleneck of optoelectronic conversion and analog-to-digital conversion can be bypassed.

### REFERENCES

### References up to First and Second Examples

The following references are incorporated by reference herein.
[1] I. Goodfellow, Y. Bengio, and A. Courville, Deep Learning, Cambridge, MIT Press, 2016.
[2] V. Sze, Y.-H. Chen, T.-J. Yang, and J. S. Emer, “Efficient processing of deep neural networks: a tutorial and survey,” Proc. IEEE, vol. 105, no. 12, pp. 2295-2329, 2017.
[3] Y. LeCun, “Deep learning hardware: past, present, and future,” in 2019 IEEE International Solid-State Circuits Conference-(ISSCC), IEEE, 2019, pp. 12-19.
[4] G. Wetzstein, A. Ozcan, S. Gigan, et al., “Inference in artificial intelligence with deep optics and photonics,” Nature, vol. 588, no. 7836, pp. 39-47, 2020.
[5] X. Lin, Y. Rivenson, N. T. Yardimci, et al., “All-optical machine learning using diffractive deep neural networks,” Science, vol. 361, no. 6406, pp. 1004-1008, 2018.
[6] T. Zhou, X. Lin, J. Wu, et al., “Large-scale neuromorphic optoelectronic computing with a reconfigurable diffractive processing unit,” Nat. Photonics, vol. 15, no. 5, pp. 367-373, 2021.
[7] Y. Zuo, B. Li, Y. Zhao, et al., “All-optical neural network with nonlinear activation functions,” Optica, vol. 6, no. 9, pp. 1132-1137, 2019.
[8] T. Wang, S.-Y. Ma, L. G. Wright, T. Onodera, B. Richard, and P. L. McMahon, An Optical Neural Network Using Less than 1 Photon Per Multiplication, 2021, arXiv preprint arXiv:2104.13467.
[9] Z. Gu, Y. Gao, and X. Liu, “Optronic convolutional neural networks of multi-layers with different functions executed in optics for image classification,” Opt. Express, vol. 29, no. 4, pp. 5877-5889, 2021.
[10] M. Miscuglio, Z. Hu, S. Li, et al., “Massively parallel amplitude-only fourier neural network,” Optica, vol. 7, no. 12, pp. 1812-1819, 2020.
[11] X. Porte, A. Skalli, N. Haghighi, S. Reitzenstein, J. A. Lott, and D. Brunner, “A complete, parallel and autonomous photonic neural network in a semiconductor multimode laser,” J. Phys. Photonics, vol. 3, no. 2, p. 024017, 2021.
[12] X. Xu, M. Tan, B. Corcoran, et al., “11 tops photonic convolutional accelerator for optical neural networks,” Nature, vol. 589, no. 7840, pp. 44-51, 2021.
[13] G. Mourgias-Alexandris, A. Tsakyridis, N. Passalis, A. Tefas, K. Vyrsokinos, and N. Pleros, “An all-optical neuron with sigmoid activation function,” Opt. Express, vol. 27, no. 7, pp. 9620-9630, 2019.
[14] F. Duport, B. Schneider, A. Smerieri, M. Haelterman, and S. Massar, “All-optical reservoir computing,” Opt. Express, vol. 20, no. 20, pp. 22783-22795, 2012.
[15] F. Duport, A. Smerieri, A. Akrout, M. Haelterman, and S. Massar, “Fully analogue photonic reservoir computer,” Sci. Rep., vol. 6, no. 1, pp. 1-12, 2016.
[16] B. J. Shastri, M. A. Nahmias, A. N. Tait, A. W. Rodriguez, B. Wu, and P. R. Prucnal, “Spike processing with a graphene excitable laser,” Sci. Rep., vol. 6, no. 1, pp. 1-12, 2016.
[17] A. Dejonckheere, F. Duport, A. Smerieri, et al., “All-optical reservoir computer based on saturation of absorption,” Opt. Express, vol. 22, no. 9, pp. 10868-10881, 2014.
[18] Y. Shen, N. C. Harris, S. Skirlo, et al., “Deep learning with coherent nanophotonic circuits,” Nat. Photonics, vol. 11, no. 7, pp. 441-446, 2017.
[19] J. Feldmann, N. Youngblood, C. D. Wright, H. Bhaskaran, and W. H. Pernice, “All-optical spiking neurosynaptic networks with self-learning capabilities,” Nature, vol. 569, no. 7755, pp. 208-214, 2019.
[20] J. Feldmann, N. Youngblood, M. Karpov, et al., “Parallel convolutional processing using an integrated photonic tensor core,” Nature, vol. 589, no. 7840, pp. 52-58, 2021.
[21] F. Ashtiani, A. J. Geers, and F. Aflatouni, Single-chip Photonic Deep Neural Network for Instantaneous Image Classification, 2021, arXiv preprint arXiv:2106.11747.
[22] S. Xu, J. Wang, H. Shu, et al., Optical Coherent Dot-Product Chip for Sophisticated Deep Learning Regression, 2021, arXiv preprint arXiv:2105.12122.
[23] B. Shi, N. Calabretta, and R. Stabile, “Inp photonic integrated multi-layer neural networks: architecture and performance analysis,” APL Photonics, vol. 7, no. 1, p. 010801, 2021.
[24] M. Miscuglio, A. Mehrabian, Z. Hu, et al., “All-optical nonlinear activation function for photonic neural networks,” Opt. Mater. Express, vol. 8, no. 12, pp. 3851-3863, 2018.
[25] A. Jha, C. Huang, and P. R. Prucnal, “Reconfigurable all-optical nonlinear activation functions for neuromorphic photonics,” Opt. Lett., vol. 45, no. 17, pp. 4819-4822, 2020.
[26] A. N. Tait, T. F. De Lima, E. Zhou, et al., “Neuromorphic photonic networks using silicon photonic weight banks,” Sci. Rep., vol. 7, no. 1, pp. 1-10, 2017.
[27] J. Crnjanski, M. Krstid, A. Totovid, N. Pleros, and D. Gvozdid, “Adaptive sigmoid-like and prelu activation functions for all-optical perceptron,” Opt. Lett., vol. 46, no. 9, p. 20032021, 2006.
[28] R. Amin, J. George, S. Sun, et al., “Ito-based electro-absorption modulator for photonic neural activation function,” APL Mater., vol. 7, no. 8, p. 081112, 2019.
[29] C. Mesaritakis, A. Kapsalis, A. Bogris, and D. Syvridis, “Artificial neuron based on integrated semiconductor quantum dot mode-locked lasers,” Sci. Rep., vol. 6, no. 1, pp. 1-10, 2016.
[30] C. Wang, C. Langrock, A. Marandi, et al., “Ultrahigh-efficiency wavelength conversion in nanophotonic periodically poled lithium niobate waveguides,” Optica, vol. 5,no. 11,pp. 1438-1441, 2018.
[31] M. Jankowski, C. Langrock, B. Desiatov, et al., “Ultrabroadband nonlinear optics in nanophotonic periodically poled lithium niobate waveguides,” Optica, vol. 7, no. 1, pp. 40-46, 2020.
[32] Q. Guo, R. Sekine, L. Ledezma, et al., Femtojoule, Femtosecond All-Optical Switching in Lithium Niobate Nanophotonics, 2021, arXiv preprint arXiv:2107.09906.
[33] L. Ledezma, R. Sekine, Q. Guo, R. Nehra, S. Jahani, and A. Marandi, Intense Optical Parametric Amplification in Dispersion Engineered Nanophotonic Lithium Niobate Waveguides, 2021, arXiv preprint arXiv:2104.08262. [34] D.-A. Clevert, T. Unterthiner, and S. Hochreiter, Fast and Accurate Deep Network Learning by Exponential Linear Units (Elus), 2015, arXiv preprint arXiv:1511.07289.
[35] T. B. Brown, B. Mann, N. Ryder, et al., Language Models Are Few-Shot Learners, 2020, arXiv preprint arXiv:2005.14165.
[36] M. Ono, M. Hata, M. Tsunekawa, et al., “Ultrafast and energy-efficient all-optical switching with graphene-loaded deep-subwavelength plasmonic waveguides,” Nat. Photonics, vol. 14, no. 1, pp. 37-43, 2020.
[37] G. Grinblat, M. P. Nielsen, P. Dichtl, Y. Li, R. F. Oulton, and S. A. Maier, “Ultrafast sub-30-fs all-optical switching based on gallium phosphide,” Sci. Adv., vol. 5, no. 6, p. eaaw3262, 2019.
[38] X. Guo, T. D. Barrett, Z. M. Wang, and A. Lvovsky, “Backpropagation through nonlinear units for the all-optical training of neural networks,” Photon. Res., vol. 9, no. 3, pp. B71-B80, 2021.
[39] I. A. Williamson, T. W. Hughes, M. Minkov, B. Bartlett, S. Pai, and S. Fan, “Reprogrammable electro-optic nonlinear activation functions for optical neural networks,” IEEE J. Sel. Top. Quant. Electron., vol. 26, no. 1, pp. 1-12, 2019.
[40] L. Deng, “The mnist database of handwritten digit images for machine learning research,” IEEE Signal Process. Mag., vol. 29, no. 6, pp. 141-142, 2012.
[41] S. Bandyopadhyay, R. Hamerly, and D. Englund, “Hardware error correction for programmable photonics,” Optica, vol. 8, pp. 1247-1255, 2021.
[42] S. Oh, Y. Shi, J. Del Valle, et al., “Energy-efficient mott activation neuron for full-hardware implementation of neural networks,” Nat. Nanotechnol., vol. 16, no. 6, pp. 680-687, 2021.
[43] O. Krestinskaya, K. N. Salama, and A. P. James, “Learning in memristive neural network architectures using analog backpropagation circuits,” IEEE Trans. Circuits Syst. I Regul. Pap., vol. 66, no. 2, pp. 719-732, 2018.
[44] Y. Huang, Z. Yang, J. Zhu, and T. T. Ye, “Analog circuit implementation of neurons with multiply-accumulate and relu functions,” in Proceedings of the 2020 on Great Lakes Symposium on VLSI, 2020, pp. 493-498.
[45] M. Giordano, G. Cristiano, K. Ishibashi, et al., “Analog-todigital conversion with reconfigurable function mapping for neural networks activation function acceleration,” IEEE J. Emerg. Sel. Top. Circuits Syst., vol. 9, no. 2, pp. 367-376, 2019.
[46] J. Choquette, W. Gandhi, O. Giroux, N. Stam, and R. Krashinsky, “Nvidia a100 tensor core gpu: performance and innovation,” IEEE Micro, vol. 41, no. 2, pp. 29-35, 2021.
[47] Q. Xie, X. Lin, Y. Wang, S. Chen, M. J. Dousti, and M. Pedram, “Performance comparisons between 7-nm finfet and conventional bulk cmos standard cell libraries,” IEEE Trans. Circuits Syst. II: Express Br., vol. 62, no. 8, pp. 761-765, 2015.
[48] C. Cole, “Optical and electrical programmable computing energy use comparison,” Opt. Express, vol. 29, no. 9, pp. 13153-13170, 2021.
[49] M. Zhang, C. Wang, P. Kharel, D. Zhu, and M. Loncar, “Integrated lithium niobate electro-optic modulators: when performance meets scalability,” Optica, vol. 8, no. 5, pp. 652-667, 2021. [50] J. Lu, A. Al Sayem, Z. Gong, J. B. Surya, C.-L. Zou, and H. X. Tang, “Ultralow-threshold thin-film lithium niobate optical parametric oscillator,” Optica, vol. 8, no. 4, pp. 539-544, 2021.
[51] Y. Yamamoto, K. Aihara, T. Leleu, et al., “Coherent ising machines-optical neural networks operating at the quantum limit,” npj Quantum Inf., vol. 3, no. 1, pp. 1-15, 2017. [52] S. Wabnitz and B. J. Eggleton, All-optical Signal Processing, vol. 194, Berlin, Springer Series in Optical Sciences, 2015.

Supplementary Material: The online version of this article offers supplementary material (https://doi.org/10.1515/nanoph-2022-0137).

### References for Third, Fourth, and Fifth Examples

The following references are incorporated by reference herein.
1 M. Jankowski, A. Marandi, C. R. Phillips, R. Hamerly, K. A. Ingold, R. L. Byer, and M. M. Fejer, “Temporal simultons in optical parametric oscillators,” Phys. Rev. Lett. 120, 053904 (2018).
2 A. Marandi, N. C. Leindecker, V. Pervak, R. L. Byer, and K. L. Vodopyanov, “Coherence properties of a broadband femtosecond mid-ir optical parametric oscillator operating at degeneracy,” Opt. Express 20, 7255-7262 (2012).
3 M. A. Luda, M. Drechsler, C. T. Schmiegelow, and J. Codnia, “Compact embedded device for lock-in measurements and experiment active control,” Rev. Sci. Instruments 90, 023106 (2019)
4 L. Ledezma, R. Sekine, Q. Guo, R. Nehra, S. Jahani, and A. Marandi, “Intense optical parametric amplification in dispersion engineered nanophotonic lithium niobate waveguides,” arXiv preprint arXiv:2104.08262 (2021).
5 L. Ledezma, R. Sekine, Q. Guo, R. Nehra, S. Jahani, and A. Marandi, “100 db/cm broadband optical parametric amplification in dispersion engineered nanophotonic lithium niobate waveguides,” in CLEO: Science and Innovations, (Optical Society of America, 2021), pp. SF1C-7.
6 C. Hu, A. Pan, T. Li, X. Wang, Y. Liu, S. Tao, C. Zeng, and J. Xia, “High-efficient coupler for thin-film lithium niobate waveguide devices,” Opt. Express 29, 5397-5406 (2021).
7 L. Deng, “The mnist database of handwritten digit images for machine learning research,” IEEE Signal Process. Mag. 29, 141-142 (2012).
8 Y. Shen, N. C. Harris, S. Skirlo, M. Prabhu, T. Baehr-Jones, M. Hochberg, X. Sun, S. Zhao, H. Larochelle, D. Englund et al., “Deep learning with coherent nanophotonic circuits,” Nat. Photonics 11, 441-446 (2017).
9 F. Stelzer, A. Rohm, R. Vicente, I. Fischer, and S. Yanchuk, “Deep neural networks using a single neuron: folded-in-time architecture using feedback-modulated delay loops,” Nat. communications 12, 1-10 (2021).
10 X. Liu, X. Yan, H. Li, Y. Chen, X. Chen et al., “Tunable single-mode laser on thin film lithium niobate,” Opt. Lett. 46, 5505-5508 (2021).
11 A. A. Sayem, R. Cheng, S. Wang, and H. X. Tang, “Lithium-niobate-on-insulator waveguideintegrated superconducting nanowire single-photon detectors,” Appl. Phys. Lett. 116, 151102 (2020)
12 L. Ledezma, A. Roy, L. Costa, R. Sekine, R. Gray, Q. Guo, R. M. Briggs, and A. Marandi, “Widely-tunable optical parametric oscillator in lithium niobate nanophotonics,” arXiv preprint arXiv:2203.11482 (2022).
13 R. Nehra, R. Sekine, L. Ledezma, Q. Guo, R. M. Gray, A. Roy, and A. Marandi, “Few-cycle vacuum squeezing in nanophotonics,” arXiv preprint arXiv:2201.06768 (2022).
14 Q. Guo, R. Sekine, L. Ledezma, R. Nehra, D. J. Dean, A. Roy, R. M. Gray, S. Jahani, and A. Marandi, “Femtojoule, femtosecond all-optical switching in lithium niobate nanophotonics,” arXiv prep
15 Further information on one or more embodiments of the present invention can be found in Li, Gordon H.Y., Sekine, Ryoto, Nehra, Rajveer, Gray, Robert M., Ledezma, Luis, Guo, Qiushi and Marandi, Alireza. “All-optical ultrafast ReLU function for energy-efficient nanophotonic deep learning” Nanophotonics, 2022.
https://doi.org/10.1515/nanoph-2022-0137.
https://www.degruyter.com/document/doi/10.1515/nanoph-2022-0137/html!lang=en

### CONCLUSION

This concludes the description of the preferred embodiment of the present invention. The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

1. A device for implementing a nonlinear activation function, comprising:
a material comprising second-order nonlinear susceptibility phase-matching a coherent nonlinear interaction involving a signal comprising a signal wavelength and a bias comprising a bias wavelength, so that:
a first phase difference between the signal and the bias induces the coherent nonlinear interaction comprising second harmonic generation (generating a second harmonic of the bias wavelength) or sum frequency generation (generating a sum frequency of the bias and the signal, and
a second phase difference between the signal and the bias induces the interaction comprising parametric amplification amplifying the bias and attenuating the signal; and
wherein:
an input for receiving:
a positive input comprising the signal having an input energy and the first phase difference, or
a negative input comprising the second phase difference, and
an output for outputting, in response to the input, an output signal comprising an output energy of the signal outputted from the material as a function of the input energy of the signal inputted to the material.

2. The device of claim 1, wherein the material comprises lithium niobate, lithium tantalate, Potassium Titanyl Phosphate (KTP), aluminum nitride, gallium arsenide, indium phosphide, or aluminum gallium arsenide.

3. The device of claim 1, wherein the material comprises a periodically poled ferromagnetic material or an orientation of the nonlinear susceptibility patterned along a length of the nonlinear material.

4. The device of claim 1, further comprising:
at least one bulk component comprising the material and selected from a fiber coupled nonlinear waveguide or bulk crystal, or
one or more photonic waveguides each comprising the material, the waveguides each having a thickness on the order of the signal wavelength so as to confine and guide the signal along the waveguide

5. The device of claim 1, wherein the signal comprises a second harmonic of the bias, the first phase difference is π/2, and the second phase difference is −π/2.

6. A photonic integrated circuit comprising the device of claim 1, further comprising:
a chip substrate;
one or more photonic waveguides, each comprising the material, on the chip substrate;
one or more bias input couplers, each of the bias input couplers coupling the bias into a different one of the photonic waveguides; and
the input comprising one or more signal input couplers, each of the signal input couplers coupling the signal into a different one of the photonic waveguides.

7. The photonic circuit of claim 6, further comprising a first circuit performing linear operations and a second circuit comprising the photonic waveguides performing the nonlinear activation functions, wherein outputs of the first circuits comprise the signals inputted into the photonic waveguides of the second circuit.

8. The photonic circuit of claim 7, wherein the first circuit comprises Mach Zehnder interferometers each having a pair of arms and a plurality of electrooptic modulators, each of the electro-optic modulators coupled to a least one of the arms so as to modulate a phase of the signal in at least one of the arms.

9. The photonic circuit of claim 6, further comprising:
one or more feedback loops between the output of each of the photonic waveguides and the input of the each of the photonic waveguides, wherein each of the feedback loops performs a linear operation and each of the feedback loops comprises a modulator for addressing each of the feedback loops at a different time step in a time-multiplexed configuration.

10. A system comprising the device of claim 1, further comprising:
a first source outputting the signal;
a second source outputting the bias;
a first amplitude modulator modulating the input energy of the signal;
a second amplitude modulator modulating an energy of the bias; and
a delay line or a phase modulator in a path transmitting the signal from the laser to the input to the nonlinear material, wherein the delay line or phase modulator sets the first phase difference or the second phase difference.

11. The system of claim 10, further comprising a computer:
outputting control signals to at least one of the first source, the second source, the first amplitude modulator, the second amplitude modulator, or the delay line or the phase modulator, wherein the control signals control the input energy and set the first phase difference and the second phase difference; and
receiving the output signal.

12. The system of claim 10, further comprising one or more detectors coupled to the output of the nonlinear material for measuring the output energy of the signal and outputting a detection signal in response thereto, and wherein the detector detects the output signal comprising an analog (continuous) output.

13. The system of claim 10, wherein:
the first source comprises a first laser outputting first electromagnetic radiation comprising the signal; and
the second source comprises:
a second laser outputting second electromagnetic radiation comprising the bias, wherein the first laser and the second laser are coherently coupled so that the first electromagnetic radiation is coherent with the second electromagnetic radiation, or
the second source comprises a frequency modulator modulating a wavelength of the signal so as to form the bias.

14. The system of claim 13, wherein the frequency modulator comprises a half harmonic generator or an optical parametric oscillator.

15. The system of claim 10, further comprising a feedback between the detector and the delay line or the phase modulator for locking the first phase difference or the second phase difference.

16. The device of claim 1, wherein:
the response of the nonlinear activation function is determined by an energy of the bias,
the nonlinear activation function comprises a RELU function, an ELU function, a GELU function, the nonlinear activation function resulting from different energies of the bias, or the nonlinear activation function resulting from pump (signal) depleted second harmonic generation in the absence of the bias, and
the phase matching is such that the nonlinear activation function is implemented with pulses of the signal each having the input energy less than:
100 femtojoules and pulses of the bias each having an energy less than 100 femtojoules and a duration of less than 100 femtoseconds, or
1000 picojoules and the pulses of the bias each having an energy of less than 1000 picojoules and the duration of less than 1000 picoseconds.

17. An optical neural network comprising the device of claim 1, wherein the optical neural network implements machine learning.

18. A method of implementing a nonlinear activation function, comprising:
inputting a positive input or a negative input, using a signal and a bias, to each of one or more waveguides each comprising a material comprising second-order nonlinear susceptibility phase-matching a coherent nonlinear interaction involving the signal comprising a signal wavelength and the bias comprising a bias wavelength, wherein:
a first phase difference between the signal and the bias induces the coherent nonlinear interaction comprising second harmonic generation (generating a second harmonic of the bias) or sum frequency generation (generating a sum frequency of the bias and the signal), and
a second phase difference between the signal and the bias induces the coherent nonlinear interaction comprising parametric amplification amplifying the bias and attenuating the signal;
wherein the positive input to the nonlinear activation function comprises the signal having an input energy and the first phase difference and the negative input to the nonlinear activation function comprising the second phase difference, and
outputting an output signal from the nonlinear activation function in response to the positive input or the negative input, the output signal comprising an output energy of the signal outputted from each of the waveguides as a function of the input energy of the signal inputted to each of the waveguides.

19. The method of claim 18, further comprising inputting the signal from one or more input layers performing linear operations, wherein the input layers are coupled to the nonlinear activation functions using spatial multiplexing or time division multiplexing.

20. The method of claim 18, further comprising:
implementing the nonlinear activation function in a neural network comprising one or more first layers and one or more second layers,
inputting the signal and the bias from the one or more first layers; and
outputting the output signals to the one or more second layers.
